(19) United States
(12) Patent Application Publication
(10) Pub. No.: US 2017/0364632 A1
(43) Pub. Date: Dec. 21, 2017

(54) GENOTYPING DEVICE AND METHOD

(71) Applicant: KABUSHIKI KAISHA TOSHIBA, Tokyo (JP)

(72) Inventors: Arika FUKUSHIMA, Tokyo (JP); Shinya UMENO, Tokyo (JP)

(73) Assignee: KABUSHIKI KAISHA TOSHIBA, Tokyo (JP)

(21) Appl. No.: 15/693,268

(22) Filed: Aug. 31, 2017

Related U.S. Application Data
(63) Continuation of application No. PCT/JP2015/060368, filed on Apr. 1, 2015.

(51) Int. Cl. G06F 19/18; G06F 19/24; G06F 19/12

(52) U.S. Cl. CPC G06F 19/18; G06F 19/12; G06F 19/24

(57) ABSTRACT

A genotyping device includes a representative value calculator, a first labeler, a model creator, a second labeler. The representative value calculator calculates a representative value for each of one or more clusters with respect to each of a plurality of SNPs. The representative value being calculated based on signal intensities of specimens included in each of the clusters. The first labeler assigns genotypes to clusters of an SNP pertaining to three clusters among the SNPs on basis of the representative values of the clusters. The model creator creates a model indicative of a relationship between the genotypes of the clusters of the SNP pertaining to the three clusters among the SNPs and the representative values of the clusters. The second labeler assigns genotypes to clusters of an SNP pertaining to one or two clusters among the SNPs on basis of the representative values of the clusters and the model.

### CROSS-REFERENCE TO RELATED APPLICATIONS

The present application is a Continuation of International Application No, PCT/JP2015/060368, filed on Apr. 01, 2015, the entire contents of which is hereby incorporated by reference.

### FIELD

Embodiments described herein relate to a genotyping device and method.

### BACKGROUND

An organism holds genetic information as a nucleotide sequence (or Deoxyribonucleic Acid (DNA)) and, in the same species, most part of the nucleotide sequence is in agreement with each other. However, a part of the nucleotide sequence differs among individuals and, in particular, a locus where a nucleotide differs at a frequency of 1% or more in a population of the same species is referred to as a single nucleotide polymorphism (SNP). In organisms having two chromosomes (diploid organisms) like humans, three types of combination patterns are formed due to the difference in the nucleotides at an SNP. Such a combination pattern is called genotype.

Since individual differences such as constitution occur among even in the same species depending upon genotypes of SNPs, the genotypes have relevance to genetic diseases and effects of medicines and their side effects. Accordingly, investigation of the genotype of a specific SNP of a certain individual enables prediction of effectiveness of medicines and/or side effects prior to actual medication.

In the case of humans, it is necessary to determine genotypes of hundreds of thousands to several millions of SNPs at once in order to discover a genotype or genotypes associated with genetic diseases and effectiveness of medicines and their side effects. As a genotyping method that realizes this, a method using a DNA microarray may be mentioned.

According to this method, first, a known nucleotide sequence of an SNP on the array side and an unknown nucleotide sequence of a certain organism (specimen) whose genotype should be determined are hybridized by the DNA microarray, and a signal intensity is measured. Next, the signal intensities of a plurality of specimens measured for the same SNP are projected on a plane and classified into clusters of the same genotype for each SNP. The genotypes are then assigned (labeled) to the respective clusters using biological findings. As a result, it is made possible to determine the genotypes of the same SNP at once for a plurality of specimens.

Meanwhile, according to the above-described traditional method, fluctuations in the signal intensities caused by experimentation environments such as temperature and humidity are not taken into consideration, so that it may happen that erroneous genotypes are assigned to the clusters. As a result, a drawback of the traditional method that the SNP whose genotype has been erroneously determined increases, causing degradation in the accuracy of the genotyping occurs.

### BRIEF DESCRIPTION OF THE DRAWINGS

FIG. 1 is a schematic diagram illustrating a DNA microarray.

FIG. 2 is a diagram for explanation of the operation of the DNA microarray.

FIG. 3 is a diagram illustrating examples of specimens plotted on a signal intensity plane.

FIG. 4 is a diagram for explanation of the positional relationship of clusters of each genotype.

FIG. 5 is a diagram for explanation of the fluctuation of the distribution of the specimens.

FIG. 6 is a diagram for explanation of the influence caused by the fluctuation of the specimen distribution.

FIG. 7 is a diagram for explanation of the outline of a genotyping method by a genotyping device according to a first embodiment.

FIG. 8 is a diagram for explanation of the outline of a genotyping method by the genotyping device according to the first embodiment.

FIG. 9 is a functional block diagram illustrating the genotyping device according to the first embodiment.

FIG. 10 is a diagram illustrating an example of signal intensity data.

FIG. 11 is a diagram illustrating an example of signal intensity data.

FIG. 12 is a diagram illustrating an example of cluster data.

FIG. 13 is a diagram illustrating examples of specimens plotted on a converted signal intensity plane.

FIG. 14 is a diagram illustrating an example of converted signal intensity data.

FIG. 15 is a diagram illustrating an example of converted signal intensity data.

FIG. 16 is a diagram illustrating an example of representative value data.

FIG. 17 is a diagram illustrating an example of a probability distribution model.

FIG. 18 is a diagram for explanation of a genotype assignment method using the probability distribution model.

FIG. 19 is a diagram illustrating an example of a result of determination of a genotype.

FIG. 20 is a diagram illustrating a hardware configuration of the genotyping device according to the first embodiment.

FIG. 21 is a flowchart schematically illustrating genotyping processing by the genotyping device according to the first embodiment.

FIG. 22 is a flowchart illustrating calculation processing of a representative value.

FIG. 23 is a diagram for explanation of a method of extracting signal intensity data.

FIG. 24 is a diagram for explanation of a method of calculating the representative value.

FIG. 25 is a diagram illustrating an example of representative value data of SNPs of three clusters.

FIG. 26 is a diagram illustrating an example of representative value data of SNPs of two clusters.

FIG. 27 is a diagram illustrating an example of representative value data of SNPs of one cluster.

FIG. 28 is a flowchart illustrating genotype assignment processing for the SNPs of the three clusters.

FIG. 29 is a diagram for explanation of a method of assigning genotypes for the SNPs of the three clusters.

FIG. 30 is a diagram illustrating an example of a result of genotype assignment for the SNPs of the three clusters.

FIG. 31 is a diagram for explanation of a method of applying the result of assignment to the cluster data.

FIG. 32 is a diagram for explanation of the method of applying the result of assignment to the representative value data.

FIG. 33 is a diagram illustrating an example of updated representative value data.

FIG. 34 is a flowchart illustrating the process of creating a probability distribution model.

FIG. 35 is a diagram for explanation of a method of extracting the representative value.

FIG. 36 is a diagram illustrating an example of the probability distribution model.

FIG. 37 is a flowchart illustrating genotype assignment processing for the SNPs of the one cluster and the two clusters.

FIG. 38 is a diagram for explanation of a genotype assignment method for the SNPs of the one cluster and the two clusters.

FIG. 39 is a diagram illustrating examples of results of the genotype assignment for the SNPs of the one cluster and the two clusters.

FIG. 40 is a functional block diagram illustrating a genotyping device according to a second embodiment.

FIG. 41 is a flowchart illustrating reassignment processing by the genotyping device according to the second embodiment.

FIG. 42 is a diagram for explanation of an assignment method A by the genotyping device according to the second embodiment.

FIG. 43 is a diagram for explanation of an assignment method B by the genotyping device according to the second embodiment.

FIG. 44 is a diagram for explanation of an assignment method C by the genotyping device according to the second embodiment.

FIG. 45 is a diagram for explanation of an assignment method D by the genotyping device according to the second embodiment.

FIG. 46 is a diagram for explanation of the assignment method A by the genotyping device according to a third embodiment.

FIG. 47 is a diagram for explanation of the assignment method B by the genotyping device according to the third embodiment.

FIG. 48 is a diagram for explanation of the assignment method C by the genotyping device according to the third embodiment.

FIG. 49 is a diagram illustrating an example of a screen of a display device.

FIG. 50 is a diagram illustrating an example of a screen of the display device.

FIG. 51 is a diagram illustrating an example of a screen of the display device.

FIG. 52 is a diagram illustrating an example of a screen of the display device.

### DETAILED DESCRIPTION

According to one embodiment, a genotyping device includes: a representative value calculator, a first labeler, a model creator and a second labeler.

The representative value calculator is configured to calculate a representative value for each of one or more clusters each including a plurality of specimens with respect to each of a plurality of SNPs, the specimens being classified based on signal intensities of the specimens into the clusters with respect to each of the SNPs, and the representative value being calculated based on the signal intensities of the specimens included in each of the clusters.

The first labeler is configured to assign genotypes to clusters of an SNP pertaining to three clusters among the SNPs on the basis of the representative values of the clusters of the SNP pertaining to three clusters.

The model creator is configured to create a model indicative of a relationship between the genotypes of the clusters of the SNP pertaining to the three clusters among the SNPs and the representative values of the clusters of the SNP pertaining to three clusters.

The second labeler is configured to assign genotypes to clusters of an SNP pertaining to one or two clusters among the SNPs on the basis of the representative values of the clusters of the SNP pertaining to one or two clusters and the model.

Embodiments of the present invention are described with reference to the drawings.

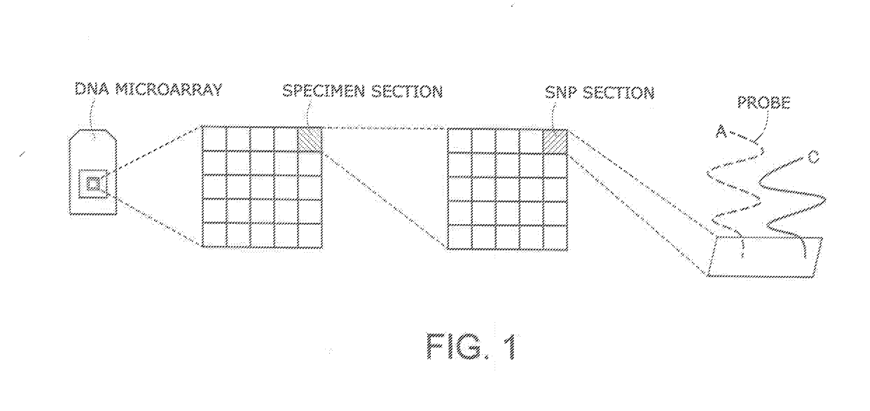

First, an outline of a genotyping technique using a DNA microarray will be described with reference to FIGS. 1 to 6. FIG. 1 is a schematic diagram that illustrates a DNA microarray. As illustrated in FIG. 1, the DNA microarray includes a plurality of specimen sections. The specimen sections individually correspond to specimens. Each specimen section has hundreds of thousands to millions of SNP sections. The SNP sections individually correspond to SNPs.

Each SNP section includes two types of probes “A” and “B,” each having a known nucleotide sequence. A probe is a mechanism for grasping two different nucleotides in each SNP, and the probes have different nucleotides of an SNP corresponding to the SNP section of this SNP. In the example of FIG. 1, the probe in which the nucleotide of the SNP is “A” and the probe in which the nucleotide of the SNP is “C” are depicted. When the DNA of the specimen is applied to this SNP section, the DNA of the specimen in which the nucleotide of the corresponding SNP is “T” is hybridized to the probe in which the nucleotide of the SNP is “A” whilst the DNA of a specimen with the nucleotide of “G” is hybridized to the probe in which the nucleotide is “C.”

When the DNAs of the specimens are hybridized to the respective probes, a signal intensity such as fluorescence intensity and electric current intensity changes. The DNA microarray measures this signal intensity for each type of the probes. In the following, one probe is referred to as probe “A,” and the other probe is referred to as probe “B.” Also, a signal whose intensity changes according to the hybridization of the probe “A” is referred to as signal “A” and the intensity of the signal “A” is referred to as signal intensity “A.” Also, a signal whose intensity changes according to the hybridization of the probe “B” is referred to as signal “B,” and the intensity of the signal “B” is referred to as signal intensity “B.”

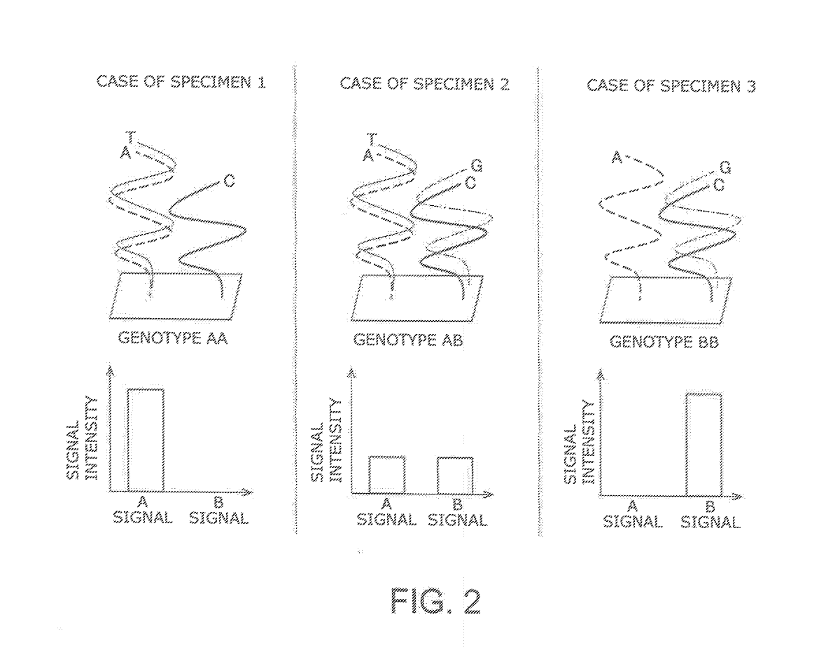

Here, it is assumed that the probe in which the nucleotide of SNPi is “A” is defined as probe “A” and a probe in which the nucleotide is “C” is defined as probe “B.” As illustrated in FIG. 2, if the genotype of an SNPs of “Specimen 1” is “TT,” then many specimens are hybridized to the probe “A” at the SNP section corresponding to the SNPi, and the signal intensity “A” increases. The genotype that increases the signal intensity “A” in this manner will be hereinafter referred to as genotype “AA. ” The genotype “AA” is a homozygous genotype.

In addition, if a genotype of an SNPi of “Specimen 2” is “TG,” similar numbers of specimens are hybridized to the probes “A” and “B,” respectively, at the SNP section corresponding to the SNPI, and the signal intensities “A” and “B” will be about the same. In this way, a genotype causing the signal intensities “A” and “B” to be about the same is hereinafter referred to as “genotype “AB,” The “genotype “AB” is a heterozygous genotype.

Further, if a genotype of an SNPi of “Specimen 3” is “GG,” then many specimens are hybridized to the probe “B” at the SNP section corresponding to the SNPi, and the signal intensity “B” increases. A genotype that increases the signal intensity “B” in this manner is hereinafter referred to as genotype “BB.” The genotype “BB” is a homozygous genotype.

The DNA microarray simultaneously measures the signal intensities “A” and “B” for a plurality of specimens in a plurality of SNPs. Subsequently, clustering of the specimens on a per-SNP basis is carried out on the basis of the signal intensities “A” and “B” measured by the DNA microarray.

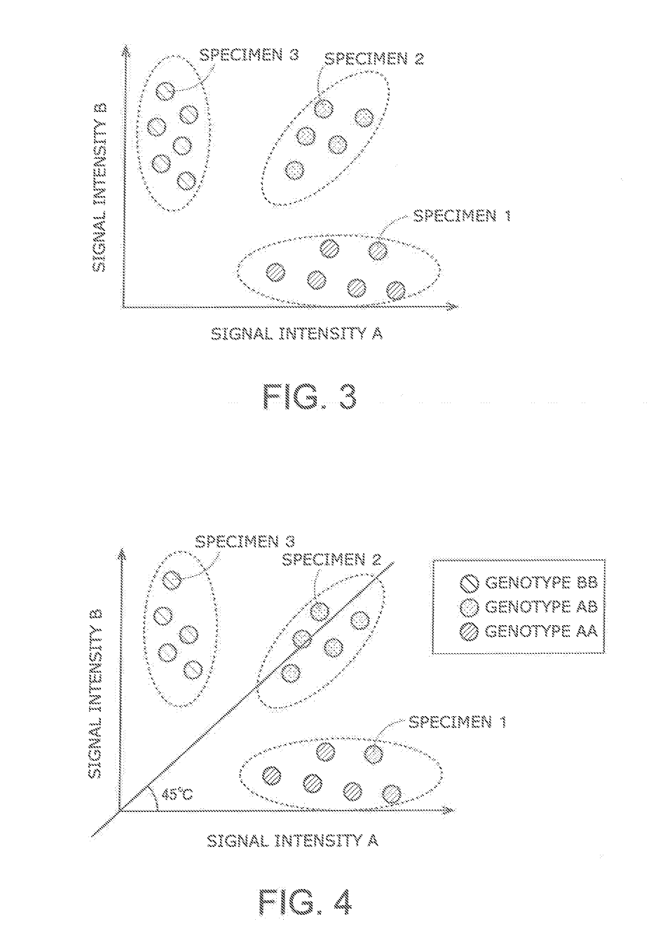

FIG. 3 is a diagram plotting specimens on a signal intensity plane for a certain SNPI, in FIG. 3, the horizontal axis represents the signal intensity “A,” the vertical axis represents the signal intensity “B,” and the broken lines represent the clusters, A cluster is a set of specimens having the same SNPI genotype. Clustering of specimens is carried out using existing clustering methodology. As a result, three or less clusters are generated for each SNP.

In addition, after the clustering, genotypes are assigned to the generated clusters. As described above, since the specimens of the genotype “AB” have the same or similar degree of the signal intensities “A” and “B,” the cluster of the genotype “AB” is considered to be distributed on or along a 45-degree straight line in the signal intensity plane. In addition, since the cluster of a genotype “AA” exhibits a large signal intensity “A” and a small signal intensity “B,” it is considered that the cluster of the genotype “AA” is distributed closer to the signal intensity “A” axis with reference to the 45-degree straight line. Since the cluster of a genotype “BB” exhibits a large signal intensity “B” and a small signal intensity “A,” it is considered that the cluster of the genotype “BB” is distributed closer to the signal intensity “B” axis with reference to the 45-degree line.

According to traditional genotyping techniques, assignment of genotypes to the clusters is performed using the magnitude relationship of the signal intensities of the individual genotypes. FIG. 4 is a diagram that illustrates the clusters of FIG. 3 to which genotypes have been assigned by such an existing technique. In FIG. 4, a genotype “AA” is assigned to a cluster near the signal intensity “A” axis, a genotype “BB” is assigned to a cluster near the signal intensity “B” axis, and a genotype “AB” is assigned to a cluster on a 45-degree line.

The traditional genotyping technique can simultaneously determine the genotypes at a plurality of SNPs of a plurality of specimens by carrying out the above processing on the individual SNPs. For example, in the example of FIG. 4, the genotype of the SNPI of “Specimen 1” is determined as being a “AA,” the genotype of the SNPI of “Specimen 2” is determined as being a genotype “AB,” and the genotype of the SNPI of “Specimen 3” is determined as being a genotype “BB.”

According to the genotype assignment method using the magnitude relationship of the signal intensities, the genotypes can be assigned with high accuracy when the signal intensities “A” and “B” are accurately measured. However, in actuality, a measurement error may occur in the signal intensities “A” and “B” due to the influence of an experimentation environment (such as a reagent of the DNA microarray) in measuring the signal intensities “A” and “B” by the DNA microarray, and the distribution of the specimens may exhibit fluctuation.

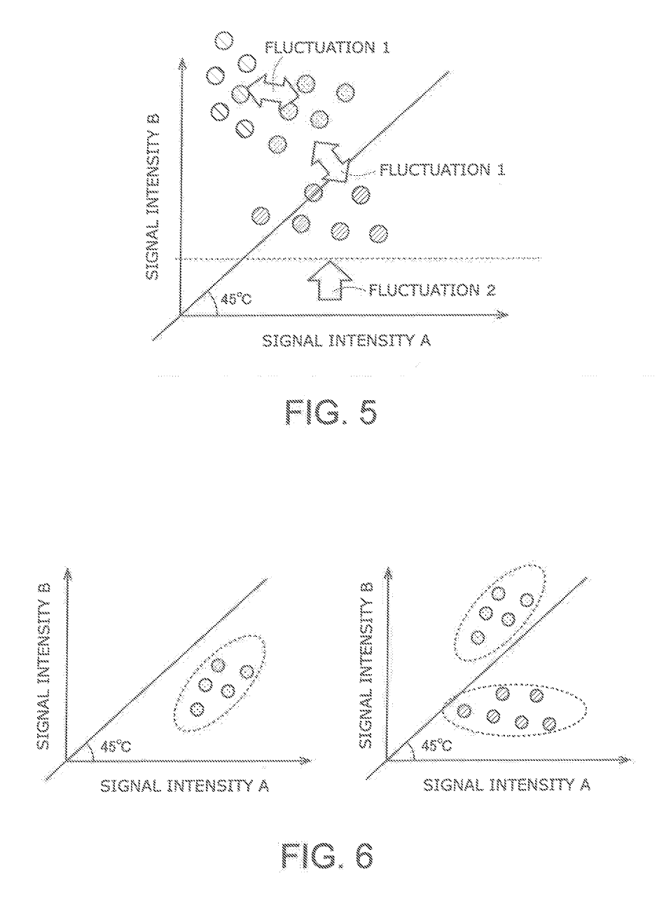

For example, as illustrated in FIG. 5, the signal intensity “A” is measured to be relatively larger than the signal intensity “B”, as a result of which the distribution of the specimens may become asymmetric (Fluctuation 1), and the distribution of the specimens may be shifted in parallel as a whole (Fluctuation 2).

As described above, if fluctuation occurs in the distribution of the specimens, it may happen that clusters other than that of the genotype “AB” may be located on the 45-degree straight line as illustrated in FIG. 5. Even in such a case, if three clusters are created for one SNP, it is still possible to correctly assign the genotypes by assigning the genotypes in the order of the signal intensities of the clusters, but, as illustrated in FIG. 6, when only one or two clusters are created for one SNP, It is difficult to assign the genotypes thereto.

This is because it is unknown how fluctuation occurs in the distribution of the specimens when only one cluster or only two clusters are created as illustrated in FIG. 6, in view of this, the genotyping device according to the following embodiments assign the genotypes to the respective clusters of the respective SNPs taking into account the fluctuation occurring in the distribution of the specimens.

### First Embodiment

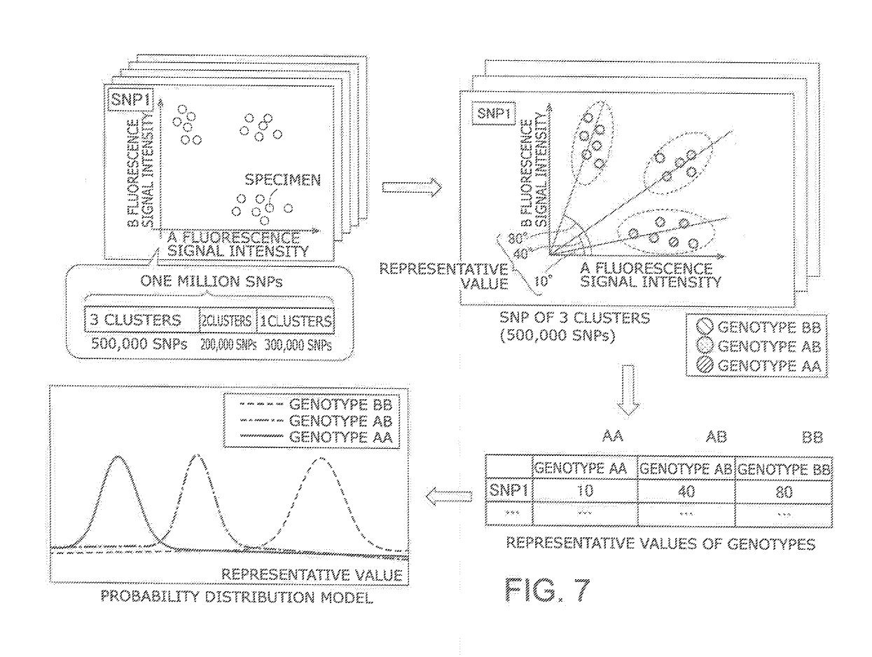

A first embodiment will be described with reference to FIGS. 7 to 39.

First, the outline of the genotyping method by the genotyping device according to the first embodiment will be described. FIGS, 7 and 8 are diagrams for explanation of the outline of the determination method by the genotyping device according to this embodiment.

In the example of FIG. 7, the signal intensities and the “cluster IDs” of 90 specimens of one million SNPs are prepared. Amongst the one million SNPs, 500,000 SNPs are classified as pertaining to three clusters, 200,000 SNPs are classified as pertaining to two clusters, and 300,000 SNPs are classified as pertaining to one cluster.

As described above, the genotyping device assigns genotypes not on a per-specimen basis but on a per-cluster basis. For this purpose, the genotyping device first calculates representative values of the clusters from the signal intensities of the specimens included in the respective clusters. The representative value is calculated for each SNP.

Next, the genotyping device assigns genotypes to the clusters of SNPs classified as pertaining to the three clusters by using the magnitude relationship of the representative values. In the example of FIG. 7, the representative values of the respective clusters of SNP1 are 10°, 40° and 80°, respectively. At this point, the genotyping device assigns genotypes “AA,” “AB” and “BB” to the three clusters in an ascending order of the representative values. By this method, the genotyping device assigns genotypes to all the clusters of 500,000 SNPs classified as pertaining to the three clusters.

As a result, representative values of the respective genotypes of 500,000 SNPs are obtained as illustrated in FIG. 7, in the example of FIG. 7, the representative values of the genotypes “AA” “AB”, and “BB” of SNP1 are 10°, 40°, and 80% respectively.

The genotyping device creates a probability distribution model using the genotypes and the representative values of 500,000 SNPs thus obtained. For example, the probability distribution model of the genotype “AA” is expressed as a probability density function of 500,000 representative values of the genotype “AA.”

Subsequently, the genotyping device assigns the genotypes to the respective clusters of SNPs classified as pertaining to the one or two clusters using the probability distribution model. Specifically, the genotyping device applies the representative values of the respective clusters to the above probability distribution model, and assigns the genotypes having the maximum probability density to the clusters.

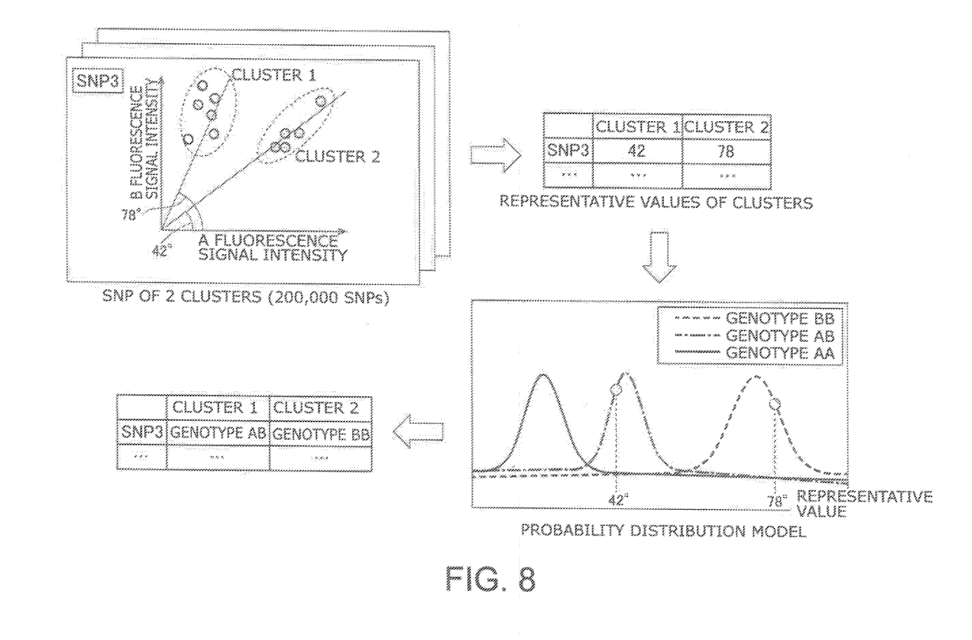

In the example of FIG. 8, the representative value of “Cluster 1” of SNP3 classified as pertaining to the two clusters is 42° and the representative value of “Cluster 2” is 78°. Applying the value 42° to the probability distribution model maximizes the probability density of the genotype “AB.” Also, applying the value 78° to the probability distribution model maximizes the probability density of the genotype “BB.” Hence, a genotype “AB” is assigned to “Cluster 1” of SNP3 and a genotype “BB” is assigned to “Cluster 2.” By this method, the genotyping device assigns genotypes to all the clusters of 200,000 SNPs classified as pertaining to the two clusters. The same applies to the 300,000 SNPs classified as pertaining to the one cluster.

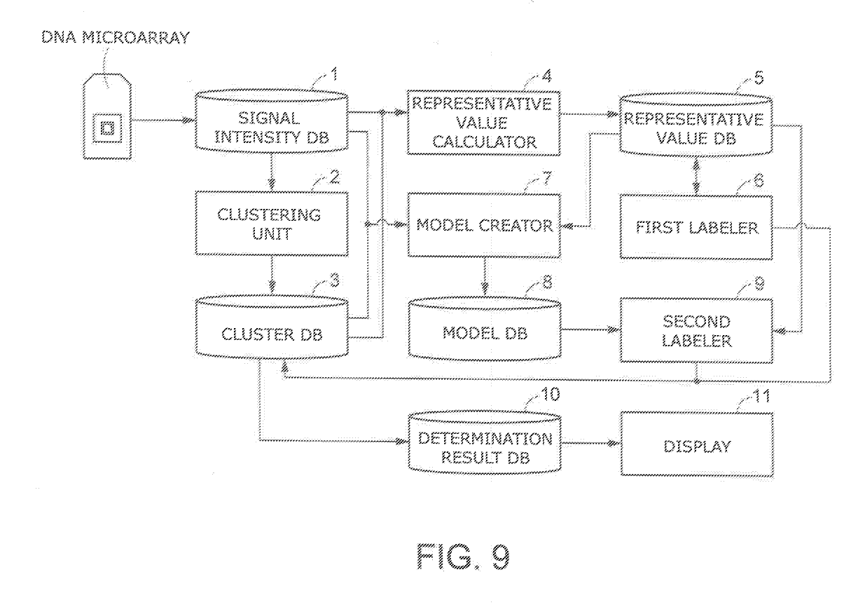

Next, the functional configuration of the genotyping device (hereinafter referred to as “determination device”) according to this embodiment will be described with reference to FIGS. 9 to 19. FIG. 9 is a functional block diagram that illustrates the determination device according to this embodiment.

As illustrated in FIG. 9, the determination device includes a signal intensity DB 1, a clustering unit 2, a cluster DB 3, a representative value calculator 4, a representative value DB 5, a first labeler 6, a model creator 7, a model DB 8, a second labeler 9, a determination result DB 10, and a display 11.

The signal intensity DB 1 is configured to store the signal intensities “A” and “B” (signal intensity data) measured by the DNA microarray. As described above, the signal intensities “A” and “B” may be a fluorescence intensity or an electric current intensity. In the following description, it is assumed that the signal intensities of SNPs 1 to “n” of the specimens 1 to “M” are respectively stored in the signal intensity DB 1. At this point, “M”×“n” signal intensities “A” and “B” are stored in the signal intensity DB 1.

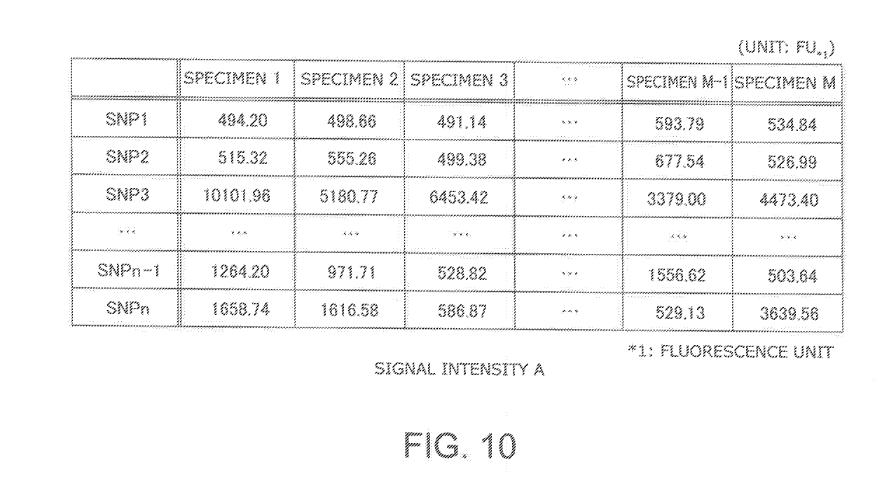

FIG. 10 is a diagram that illustrates an example of the signal intensities “A” stored in the signal intensity DB 1, in FIG. 10, the signal intensity “A” is a fluorescence intensity and “FU” is a fluorescence unit. As illustrated in FIG. 10, the signal intensities “A” of SNPs 1 to “n” of the specimens 1 to “M” are stored in the signal intensity DB 1. For example, in the example of FIG. 10, the signal intensity “A” of the SNP1 of Specimen 1 is 494.20 FU.

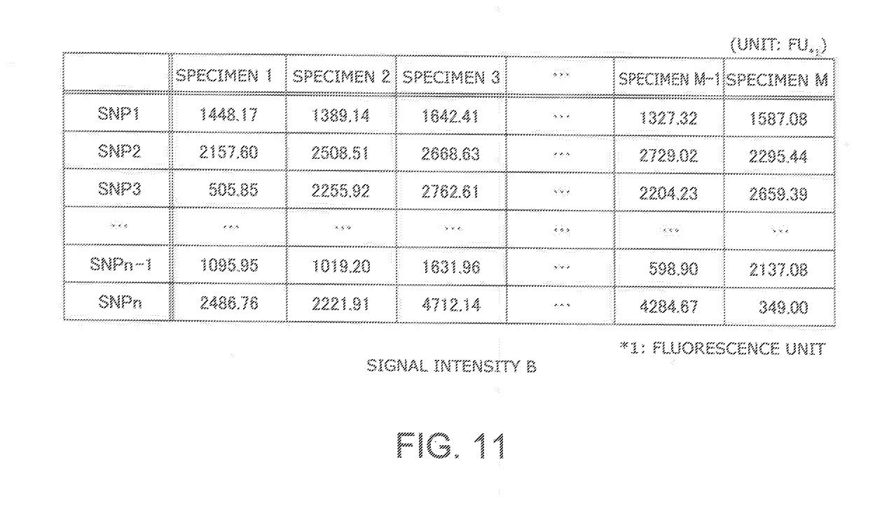

FIG. 11 is a diagram that illustrates an example of the signal intensities B stored in the signal intensity DB 1, in FIG. 11, the signal intensity “B” is a fluorescence intensity and “FU” is a fluorescence unit. As illustrated in FIG. 11, the signal intensity DB 1 stores the signal intensities “B” of the SNPs 1 to “n” of the specimens 1 to “M.” For example, in the example of FIG. 11, the signal intensity “B” of the SNP1 of Specimen 1 is 1448.17 FU.

The clustering unit 2 is configured to create a cluster or clusters for each SNP based on the signal intensities “A” and “8” stored in the signal intensity DB 1. A cluster is a set of specimens. The specimens are each classified as pertaining to one of the clusters generated by the clustering unit 2. When the specimen is a human, there are only three genotypes “AAt” “AB” and “BB,” so that three or fewer clusters are generated for each SNP. The clustering unit 2 may perform clustering of specimens using a well-known clustering method such as a k-means method.

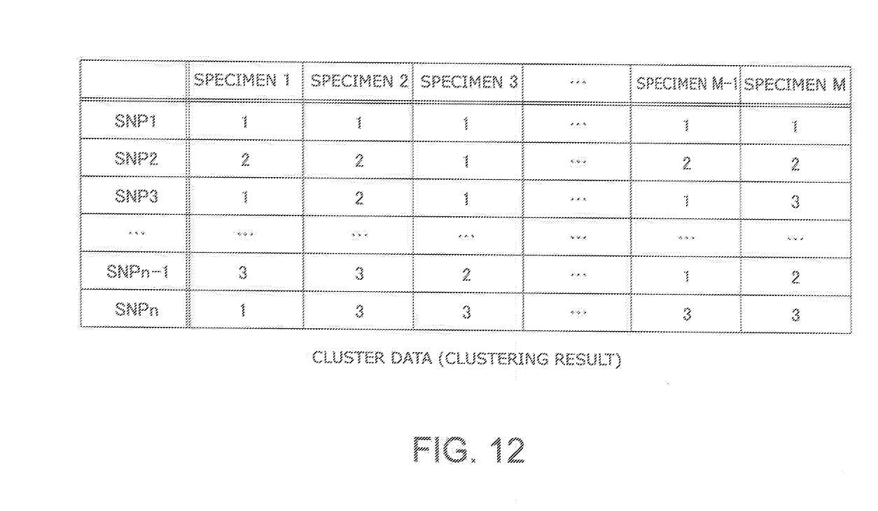

The cluster DB 3 is configured to store the result of clustering (cluster data) carried out by the clustering unit 2. Specifically, the cluster DB 3 stores cluster Information of the respective specimens with the respective SNPs. FIG. 12 is a diagram that illustrates an example of the result of clustering stored in the cluster DB 3. In the example of FIG. 12, the cluster of “Specimen 1” at SNP1 is “Cluster 1.” SNPI is classified as pertaining to one cluster, SNP2 is classified as pertaining to two clusters, and SNP 3 is classified as pertaining to three clusters.

It should be noted that the determination device may acquire the clustering result as illustrated in FIG. 12 from an external device. in that case, the determination device may not include the clustering unit 2.

In addition, the clustering unit 2 may calculate converted signal intensities “x” and “y” from the signal intensities “A” and “B” and carry out the clustering based on the converted signal intensities “x” and “y.” The converted signal intensities “x” and “y” are calculated, for example, by the following expressions.

[Expression 1]

x=log(B/A) . . . (1)

y=1/2 log(A*B) . . . (2)

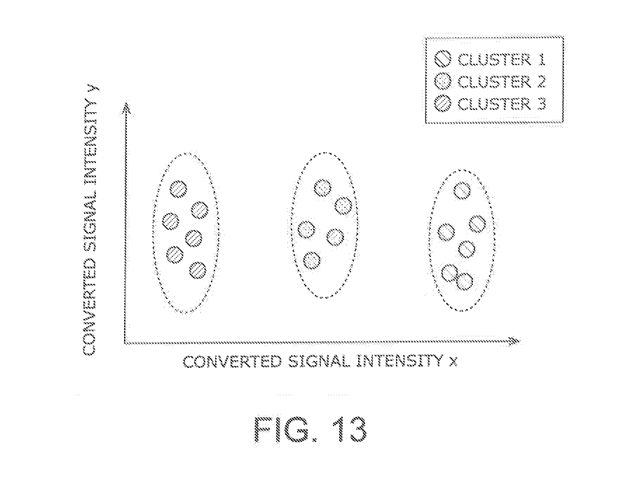

When the clustering is carried out using the converted signal intensities “x” and “y” calculated by the expressions (1) and (2), the specimens are plotted on a plane of the converted signal intensity defined by an axis representing the converted signal intensity “x” and another axis representing the converted signal intensity “y,” as illustrated in FIG. 13, and clusters are generated in the converted signal intensity plane. As illustrated in FIG. 13, the clusters generated in the converted signal intensity are those that correspond to the magnitude of the converted signal intensity “x,” and correspond to the clusters of the genotypes “AA,” “AB,” and “BB” in an ascending order of the converted signal intensities “x.”

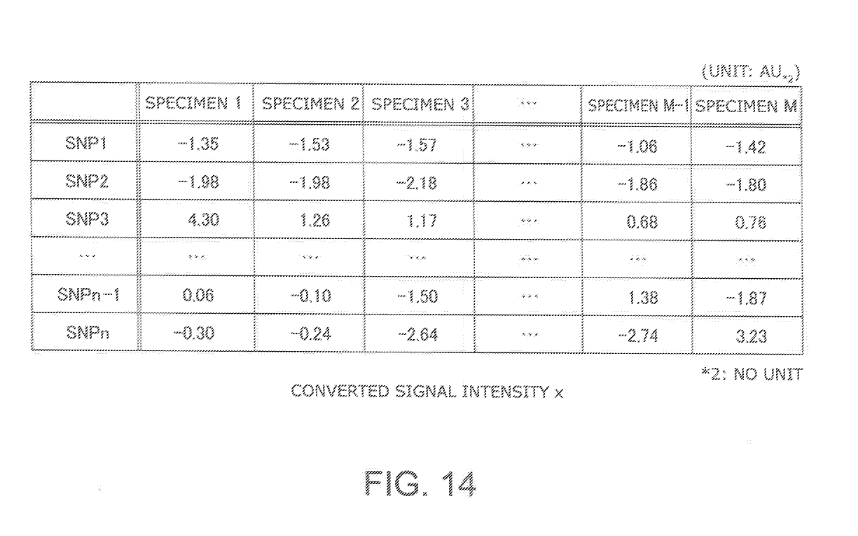

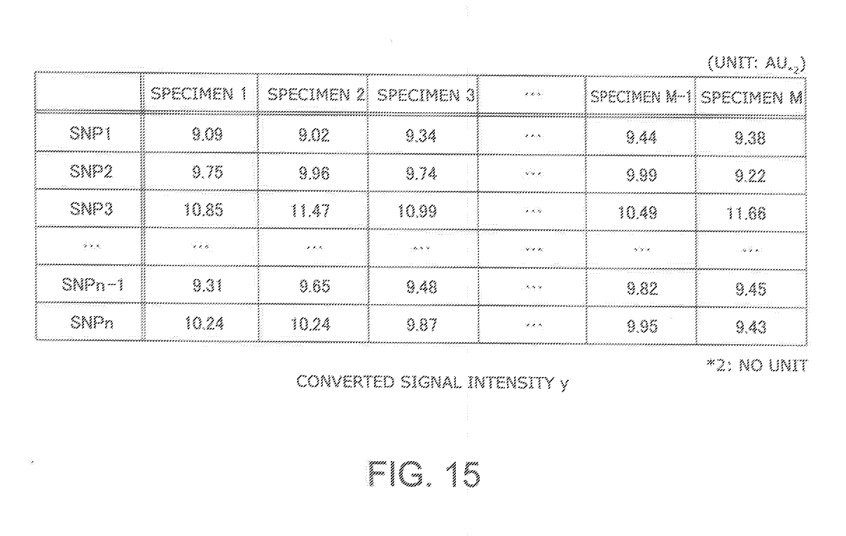

The converted signal intensities “x” and “y” calculated by the clustering unit 2 may be stored in the signal intensity DB 1. FIG. 14 is a diagram that illustrates an example of the converted signal intensities “x” stored in the signal intensity DB 1, and FIG. 15 is a diagram that illustrates an example of the converted signal intensities “y” stored in the signal intensity DB 1. in FIGS. 14 and 15, the converted signal intensities “x” and “y” are dimensionless. The determination device may use the converted signal intensities “x” and “y” stored in the signal intensity DB 1 instead of the signal intensities “A” and “B”

The representative value calculator 4 is configured to calculate representative values of the clusters generated by the clustering unit 2. The representative value is a value unique to each cluster of each SNP. in this embodiment, the representative values are calculated based on the signal intensities A, B and the converted, signal intensities “x” and “y” of the specimen included in each cluster of each SNP, in the following, It is assumed that the representative values are calculated based on the signal intensities “A” and “B.”

The representative value is, for example, a regression coefficient of a regression line of each cluster, an arc tangent of a regression coefficient, or an inclination of an approximate straight line passing through the origin, but it is not limited thereto. The representative value may be a correlation coefficient of each cluster, a cluster center value, a cluster median value, a cluster variance, an average value of ratios, or an average value of differences.

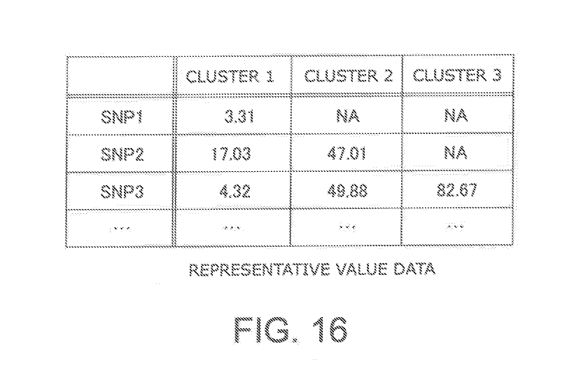

The representative value DB 5 stores the representative values (representative value data) of the respective clusters of the respective SNPs calculated by the representative value calculator 4.FIG. 16 is a diagram that illustrates an example of the representative values stored in the representative value DB 5. In the example of FIG. 16, one value is stored as a representative value of each cluster. In FIG. 16, for example, the representative value of “Cluster 1” of SNP1 is 3.31, and the representative values of “Cluster 2” and “Cluster 3” are NA (not available), NA indicates the fact that a representative value is not stored. This corresponds to the fact that only one cluster is generated for SNP1.

The first labeler 6 is configured to refer to the representative value DB 5 and extracts SNPs for which three clusters have been generated. The SNP for which three clusters are generated corresponds to an SNP for which representative values are stored for three clusters. For example, in the example of FIG. 16, SNP3 is extracted.

Next, the first labeler 6 assigns a genotype to each of the clusters of each of the extracted SNP or SNPs. Genotype assignment is carried out using the magnitude relationship of the representative values, More specifically, when a value that increases as the signal intensity “A” of the specimen included in the cluster increases is calculated as the representative value, then the first labeler 6 sequentially assigns genotypes “AA,” “AB,” and “BB.” Likewise, when a value that increases as the signal intensity “B” of the specimen included in the cluster increases is calculated as the representative value, then the first labeler 6 assigns the genotypes “BB” “AB,” and “AA” in a descending order of the representative value. This also applies to a case where the representative values are calculated based on the converted signal intensities “x” and “y.”

For example, when the representative value is a regression coefficient of each cluster on the signal intensity plane in FIG. 3, the representative value becomes large as the signal intensity “B” increases. Accordingly, the first labeler 6 assigns the genotypes “BB,” “AB,” and “AA” to three clusters in a descending order of the representative values. Consequently, in the example of FIG. 16, the genotype “AA” is assigned to “Cluster 1” the genotype “AB” is assigned to “Cluster 2,” and the genotype “BB” is assigned to “Cluster 3.”

The first labeler 6 applies the result of assignment to the cluster data stored in the cluster DB 3 and thereby generates the result of determination of the genotype of the SNP classified as pertaining to three clusters. The result of determination is stored in the determination result DB 10.

The model creator 7 creates a probability distribution model indicative of the relationship between the genotype and the representative value on the basis of the genotype of each cluster assigned by the first labeler 6 and the representative value of each cluster to which the genotype is assigned. The probability distribution model is constituted by probability density functions of the representative values for the respective genotypes. The probability variable of each probability density function is a representative value.

As the probability distribution model, a probability density function according to an appropriate probability distribution such as Gaussian distribution (normal distribution), mixed Gaussian distribution, F distribution, and beta distribution can be used. Also, each probability density function may follow different types of distribution for each genotype. For example, it may be considered that the probability density functions of the genotypes “AA” and “BB” follow a mixed Gaussian distribution, and the probability density function of the genotype “AB” follows a normal distribution.

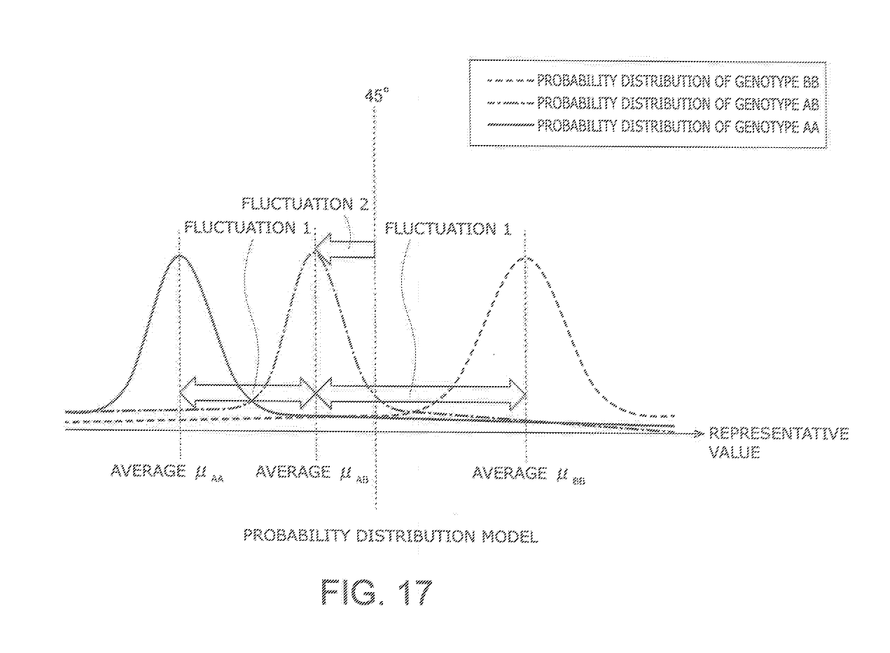

FIG. 17 is a diagram that illustrates an example of the probability distribution model created by the model creator 7, in the example of FIG. 17, the representative value is a slope of an approximate straight line passing through the origin. In FIG. 17, the probability density functions of the genotypes “AA,” “AB,” and “BB” are illustrated in this order starting from the left.

When the signal intensities “A” and “B” are accurately measured, the probability distributions of the genotypes “AA” and “BB” become symmetric with respect to the probability distribution of the genotype “AB.” Also, the probability distribution of the genotype “AB” has an average value of about 45°. In contrast, in the probability distribution model of FIG. 17, the probability distributions of the genotypes “AA” and “BB” are asymmetric (Fluctuation 1), and the average value of the probability distribution of the genotype “AB” deviates from 45° (Fluctuation 2).

In this manner, by using the genotypes and the representative values assigned by the first labeler 6, the model creator 7 can create a probability distribution model reflecting the fluctuations of the distributions due to the influence of the experimentation environment.

The model DB 8 is configured to store the probability distribution model created by the model creator 7. Specifically, parameters (average, variance, etc,) of the probability density function for each genotype are stored therein.

The second labeler 9 refers to the representative value DB 5 and extracts SNPs for which one or two clusters are generated. The SNPs for which one or two clusters are generated respectively correspond to the SNPs for which representative values are stored for one or two clusters. For example, in the example of FIG. 16, SNP1 and SNP2 are extracted.

Next, the second labeler 9 assigns genotypes to the clusters of the respective SNPs that have been extracted. The assignment of the genotypes is carried out using the probability distribution model stored in the model DB 8, More specifically, the second labeler 9 assigns the representative values of the respective clusters to the probability density functions of the respective genotypes, and assigns the genotype having the maximum probability density to each cluster.

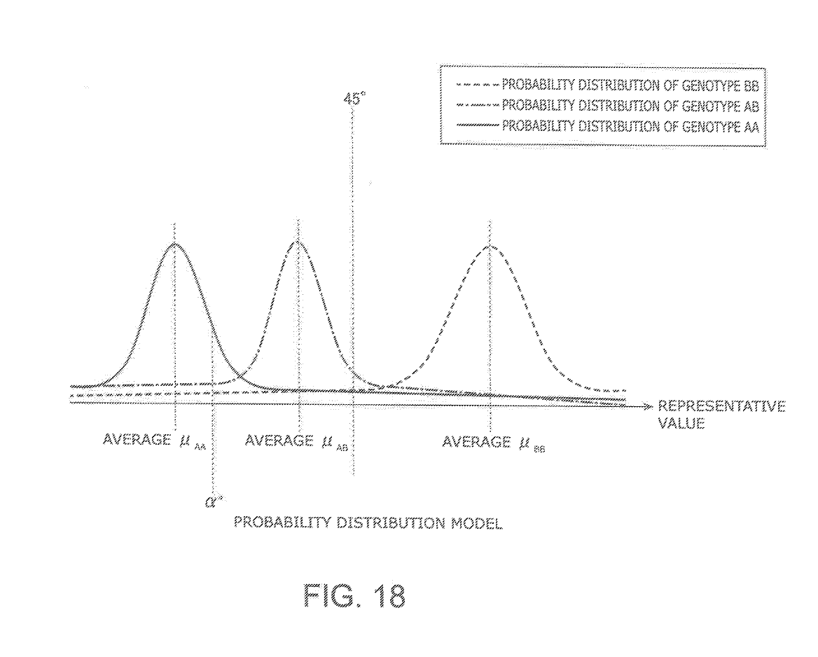

For example, as illustrated in FIG. 18, if the representative value of “Cluster 1” of SNP1 is α°, then “Cluster 1” has the maximum probability density in the probability density function of the genotype “AA.” Accordingly, the second labeler 9 assigns the genotype “AA” to “Cluster 1” of SNP1.

The result of determination of the genotype of the SNP classified as pertaining to one or two clusters is generated by the second labeler 9 which applies the result of assignment to the cluster data stored in the cluster DB 3. The result of determination is stored in the determination result DB 10.

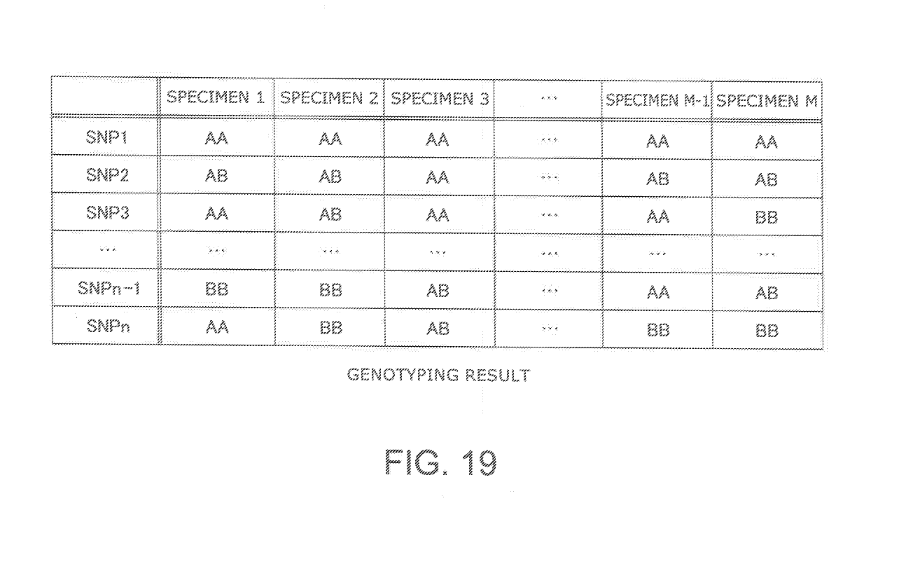

The determination result DB 10 stores therein the result of determination of the genotype of each SNP of each specimen. The result of determination is generated by applying the genotypes assigned by the first labeler 6 and the second labeler 9 to the respective clusters stored in the cluster DB 3. FIG. 19 is a diagram that illustrates an example of the result of determination of the genotype stored in the determination result DB 10, in the example of FIG. 19, SNP1 of “Specimen 1” has the genotype “AA.”

The display 11 is configured to convert the various kinds of information generated by the determination device into image data and video data, and display the image data and video data on the display device 103 (which will be described later). in the example of FIG. 9, the display 11 is connected only to the determination result DB 10, but It may be connected to the signal intensity DB 1, the cluster DB 3, the representative value DB 5, and the model DB 8. The screen of the display 11 will be described later.

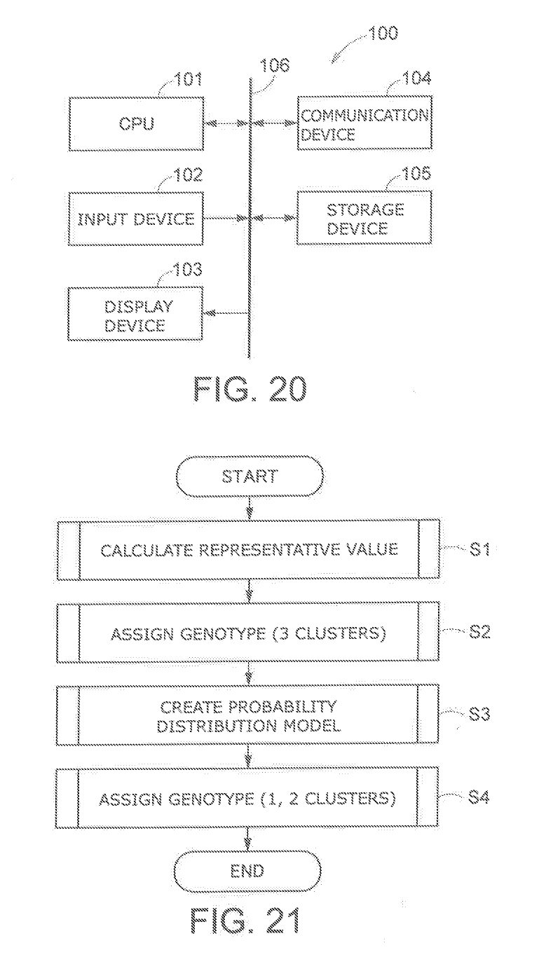

Next, a hardware configuration of the determination device according to this embodiment will be described with reference to FIG. 20. As illustrated in FIG. 20, the determination device according to this embodiment is configured by a computer 100. The computer 100 includes a central processing unit (CPU) 101, an input device 102, a display device 103, a communication device 104, and a storage device 105, which are connected to each other via a bus 106.

The CPU 101 is a control device and a computing device of the computer 100. The CPU 101 performs arithmetic processing based on data and programs input from the individual devices (e.g., the Input device 102, the communication device 104, and the storage device 105) connected via the bus 106, and outputs results of calculation and control signals to the devices (e.g., the display device 103, the communication device 104, and the storage device 105) connected via the bus 106.

Specifically, the CPU 101 runs an operating system (OS) of the computer 100, a determination program, and the like, and controls the devices constituting the computer 100. The determination program is a program that causes the computer 100 to implement the above-described functions of the determination device. When the CPU 101 runs the determination program, the computer 100 functions as the determination device.

The input device 102 is a device for inputting information to the computer 100. Examples of the input device 102 may include, but is not limited to, a keyboard, a mouse, and a touch panel. By using the input device 102, a user (operator) of the determination device can cause the determination device to start the determination processing or to input the parameters of the probability distribution model.

The display device 103 is a device for displaying images and videos. Examples of the display device 103 may include, but is not limited to, an LCD (liquid crystal display), a CRT (cathode ray tube), and a PDP (plasma display). Image data generated by the display 11 is displayed on the display device 103.

The communication device 104 is a device for allowing the computer 100 to make wired or wireless communications with an external device. Examples of the communication device 104 may include, but is not limited to, a modem, a hub, and a router. Information such as the signal intensity measured by the DNA microarray and the clustering results of the specimens can be input from the external device via the communication device 104.

The storage device 105 is a storage medium that stores therein the OS of the computer 100, the determination program, data necessary for running the determination program, data generated by execution of the determination program, and the like. The storage device 105 includes a main storage device and an external storage device. Examples of the main storage device may include, but is not limited to, RAM, DRAM, and SRAM. Also, examples of the external storage device may include, but is not limited to, a hard disk, an optical disk, a flash memory, and a magnetic tape. The signal intensity DB 1, the cluster DB 3, the representative value DB 5, the model DB 8, and the determination result DB 10 can be configured using the storage device 105.

It should be noted that the computer 100 may include one or more of the CPU 101, the Input device 102, the display device 103, the communication device 104, and the storage device 105, and peripheral devices such as a printer and a scanner may be connected thereto.

Also, the determination device may be constituted by a single computer 100, or may be configured as a system including a plurality of Interconnected computers 100.

Further, the determination program may be stored in advance in the storage device 105 of the computer 100, recorded in a computer-readable recording medium such as a CD-ROM, or uploaded on the Internet. In any case, the determination device can be configured by installing the determination program onto the computer 100 and executing it.

Next, the determination processing executed by the determination device according to this embodiment will be described with reference to FIGS. 21 to 39. In the following description, it is assumed that the clustering by the clustering unit 2 is completed and clusters of SNPs 1 to “n” of Specimens 1 to “M” are stored in the cluster DB 3

First, the outline of the determination processing will be described. FIG. 21 is a flowchart that schematically illustrates the determination processing. As illustrated in FIG. 21, when the determination processing is started, the representative value calculator 4 calculates representative values of each cluster of SNPs 1 to “n” in step S1. In the next step S2, the first labeler 6 assigns a genotype to each cluster of SNPs classified as pertaining to three clusters, the assignment being performed using the magnitude relationship of the representative values. Subsequently, the model creator 7 creates a probability distribution model on the basis of the genotypes assigned to the clusters by the first labeler 6 and the representative values of the clusters to which the genotypes are assigned. In step S4, the second labeler 9 assigns a genotype to each cluster of the SNPs classified as pertaining to one or two clusters using the probability distribution model.

Through the above processing, genotypes are assigned to each cluster of SNPs 1 to “n” of Specimens 1 to “M,” and the determination processing is completed. The result of determination is stored in the determination result DB 10.

Here, details of each process of the above-described steps S1 to S4 will be specifically described.

(Step S1)

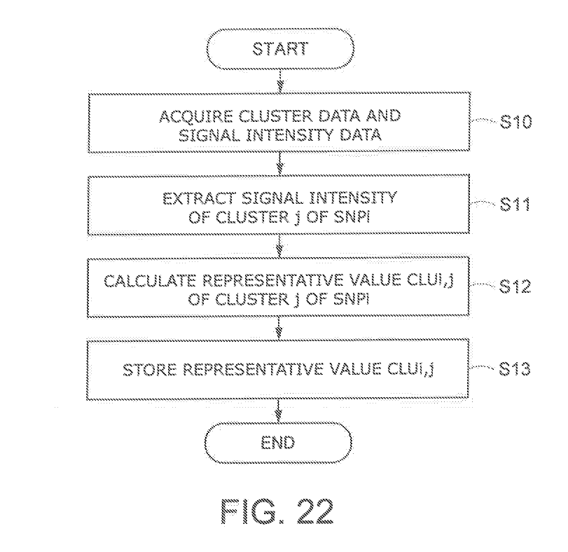

First, the representative value calculation process in step S1 will be describe. FIG. 22 is a flowchart that illustrates the representative value calculation process. In the following description, the representative value is assumed to be the slope of an approximate curve passing through the origin on the signal intensity plane.

First, in step S10, the representative value calculator 4 acquires the signal intensity data stored in the signal intensity DB 1 and the cluster data stored in the cluster DB 3.

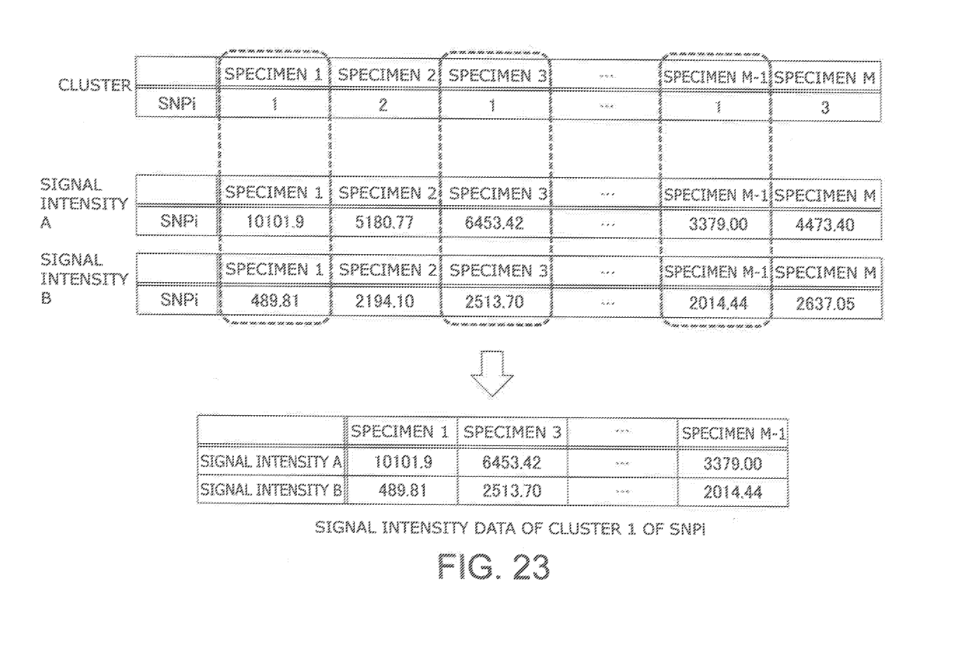

Next, in step S11, the representative value calculator 4 extracts the signal intensities “A” and “B” of “Cluster j” of SNPi, where “i” is an integer from 1 to “n” and “j” is an integer from 1 to 3. For example, when extracting the signal intensity of “Cluster 1” of SNPi. the representative value calculator 4 first refers to the cluster data of SNPi and extracts the specimens of “Cluster 1” as illustrated in FIG. 23. In the example of FIG. 23, the specimens of the Cluster 1 are “Specimens 1,” “Specimen 3,” and “Specimen M-1.”

Next, the representative value calculator 4 refers to the signal intensity data and extracts the signal intensities “A” and “B” of the specimens of “Cluster 1,” As a result, as illustrated in FIG. 23, the signal intensities “A” and “B” of “Cluster 1” of SNPI are extracted.

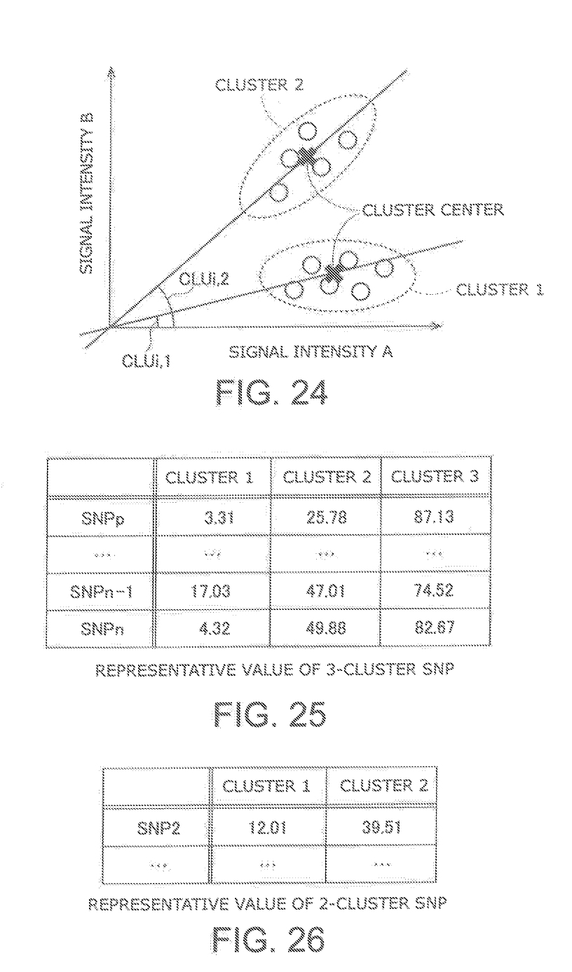

Subsequently, in step S12, the representative value calculator 4 calculates a representative value “CLU(l,j)” of “Cluster j” of SNPi, The representative value “CLU(l,j)” is the slope (angle) of the approximate straight line of “Cluster j.” FIG. 24 is a diagram that illustrates an example of the representative value “CLU(i,j).” In the example of FIG. 24, the representative value “CLU(i,1)” of “Cluster 1” of SNPI and the representative value CLU(i,2) of “Cluster 2” are illustrated. As illustrated in FIG. 24, the approximate straight line is a straight line passing through the origin of the signal intensity plane and the cluster center of “Cluster j.” The representative value “CLU(i,j)” is calculated by the following expression.

CLU(l,j)=tan⁻¹(average B(l,j))/(average A(l,j)) . . . (1)

In the expression (1), B(i,j) is the signal intensity “B” of “Cluster j” of SNPi, and A(i,j) is the signal intensity “A” of “Cluster j” of SNPi. The coordinates of the cluster center of “Cluster j” of SNPi are (average A(i,j),average B(i,j)). The representative value calculator 4 calculates the representative value “CLU(i,j)” by assigning the signal intensities “A” and “B” of “Cluster j” of SNPi extracted in step S11.

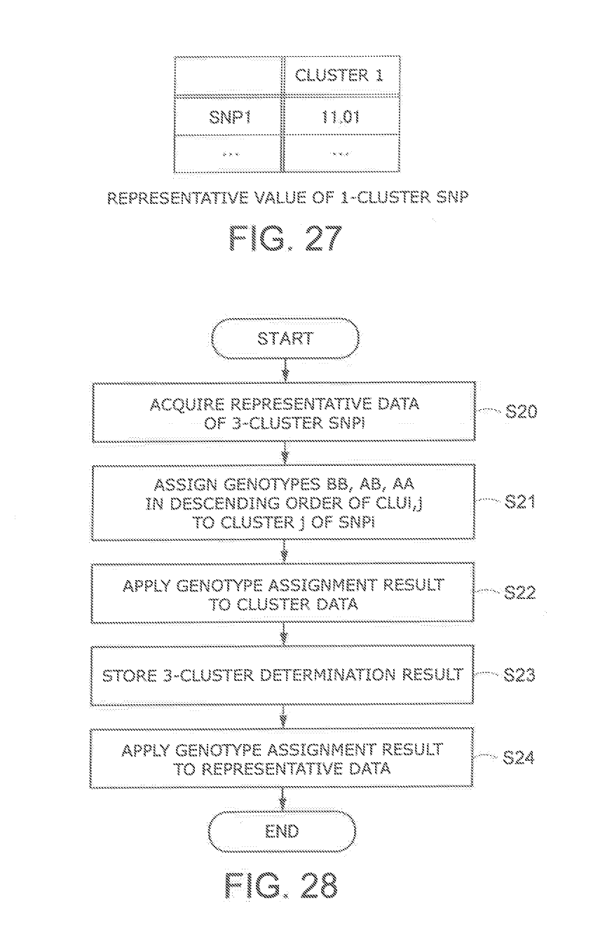

Further, in step S13, the representative value calculator 4 stores the calculated representative value “CLU(i,j)” in the representative value DB 5.FIGS. 25 to 27 are diagrams that illustrate examples of the representative value “CLU(i,j)” stored in the representative value DB 5.FIG. 25 illustrates the representative values “CLU(i,j)” of SNPs classified as pertaining to three clusters, FIG. 26 illustrates the representative values “CLU(i,j)” of SNPs classified as pertaining to two clusters, and FIG. 27 illustrates the representative values “CLU(i,j)” of SNPs classified as pertaining to one cluster.

As illustrated in FIGS, 25 to 27, the representative value DB 5 may have different tables for the respective numbers of clusters of SNPs. Further, as illustrated in FIG. 16, the representative value DB 5 may include one table. In this case, NA is stored as the representative value of “Cluster 3” of SNPi classified as pertaining to the two clusters as in the case of SNP2 in FIG. 26. As in the case of SNPi of FIG. 27, NA is stored as the representative values of “Cluster 2” and the representative value of “Cluster 3” of SNPi classified as pertaining to the one cluster.

(Step S2)

Next, the genotype assignment processing for three-cluster SNPs (SNPs classified as pertaining to the three clusters) in step S2 will be described. FIG. 28 is a flowchart that illustrates the genotype assignment processing for the three-cluster SNPs.

First, in step S20, the first labeler 6 acquires representative value data of three-cluster SNPI from the representative value DB 5, As a result, a table as illustrated in FIG. 25 which stores therein the representative values CLU(i,1) to CLU(i,3) is acquired.

Next, in step S21, the first labeler 6 refers to the cluster data and assigns genotypes to “Clusters 1” to “3” of each SNPi.

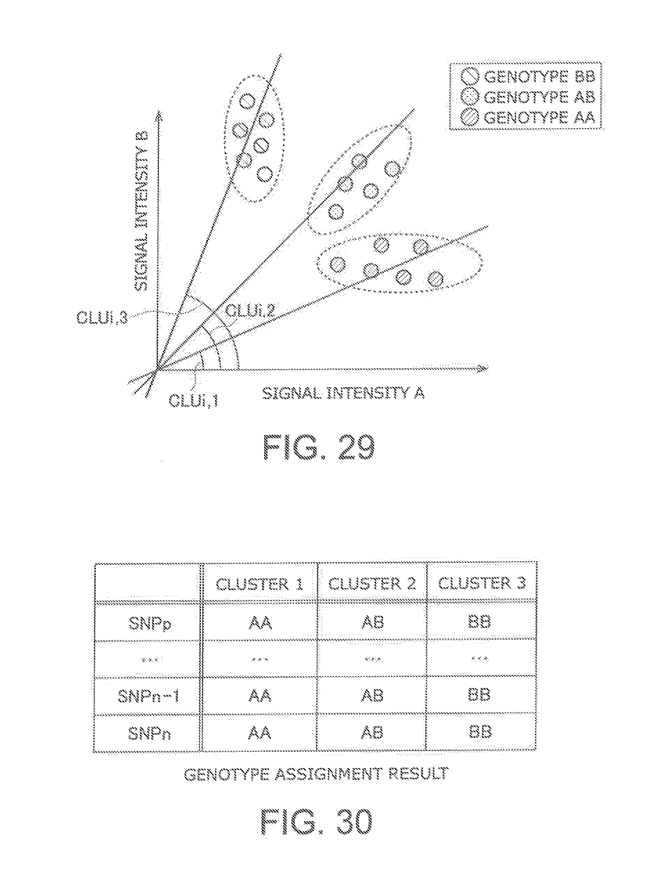

As illustrated in FIG. 29, the representative value “CLU(i,J)” decreases as the signal intensity “A” increases and increases as the signal intensity “B” increases. Accordingly, the first labeler 6 assigns the genotypes “BB,” “AB,” and “BB” to the “Clusters 1 to 3” in a descending order of the representative value “CLU(i,j).” For example, in the example of FIG. 25, the genotype “AA” is assigned to “Cluster 1” of SNPn, the genotype “AB” to the “Cluster 2,” and the genotype “BB” to the “Cluster 3.”

FIG. 30 is a diagram that illustrates an example of the result of the genotype assignment performed by the first labeler 6. Such a result of assignment is held in the first labeler 6, Further, the result of assignment may be stored in the determination result DB 10.

Subsequently, in step S22, the first labeler 6 applies the result of assignment of the genotypes for SNPI to the cluster data. Specifically, the first labeler 6 replaces the cluster of each specimen of SNPI stored in the cluster DB 3 with the genotype assigned to each cluster of SNPi.

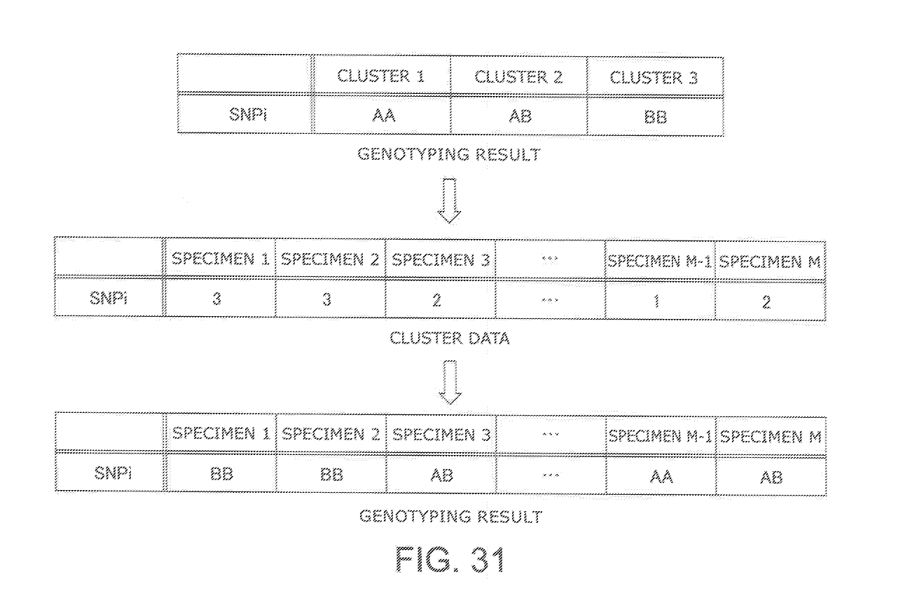

FIG. 31 is a diagram for explanation of a method of applying the result of assignment to the cluster data. in the example of FIG. 31, the genotypes “AA,” “AB,” and “BB” are assigned to “Cluster 1,” “Cluster 2,” and “Cluster 3” of SNPi, respectively. For this reason, “Cluster 1,” “Cluster 2,” and “Cluster 3” of SNPi in the cluster data are replaced with genotypes “AA,” “AB,” and “BB,” respectively.

When the first labeler 6 applies the result of assignment, the result of determination of the genotypes of the three-cluster SNP as illustrated in FIG. 19 is generated.

In addition, in step S23, the generated result of determination is stored in the determination result DB 10.

Also, in step S24, the first labeler 6 applies the result of assignment of the genotype for SNPI to the representative value data. Specifically, the first labeler 6 replaces the “Cluster j” of each representative value “CLU(i,j)” stored in the representative value DB 5 with the genotype assigned to each “Cluster j” of SNP1, and sorts them by the genotypes.

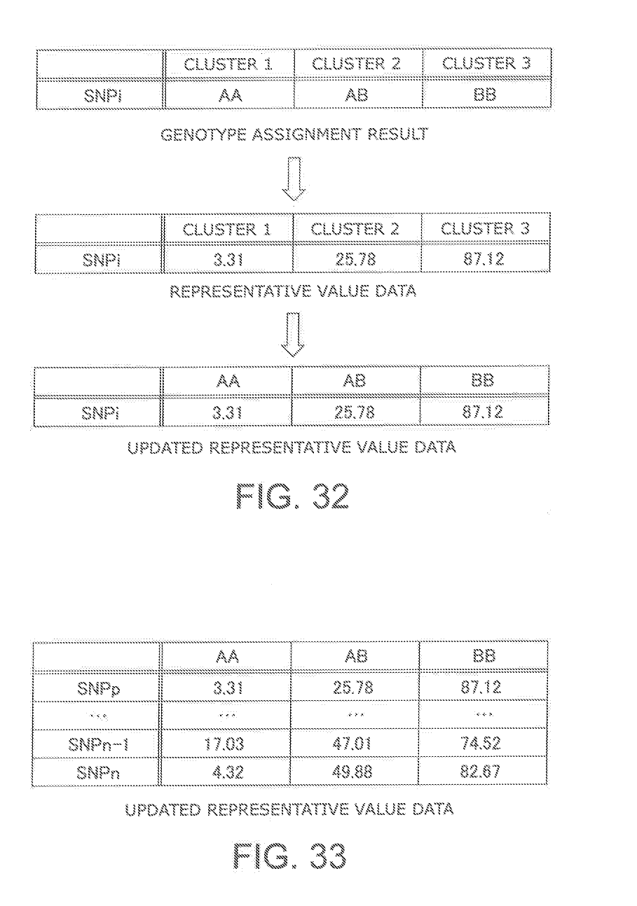

FIG. 32 is a diagram for explanation of the method of applying the result of assignment to the representative value data. In the example of FIG. 32, the genotypes “AA,” “AB,” and “BB” are assigned to “Cluster 1” “Cluster 2,” and “Cluster 3” of SNPi, respectively. Accordingly, “Cluster 1,” “Cluster 2,” and “Cluster 3” of SNPi in the representative value data are replaced with the genotypes “AA,” “AB,” and “BB,” respectively.

In addition, the first labeler 6 sorts the representative values “CLU(i,j)” by genotypes. As a result, the representative value DB 5 is updated. FIG. 33 is a diagram that illustrates an example of the updated representative value data. in the example of FIG. 33, the representative values of SNPs are sorted in the order of the genotypes “AA,” “AB,” and “BB.” For example, the representative value of genotype “AA” of SNPn is 4.32.

(Step S3)

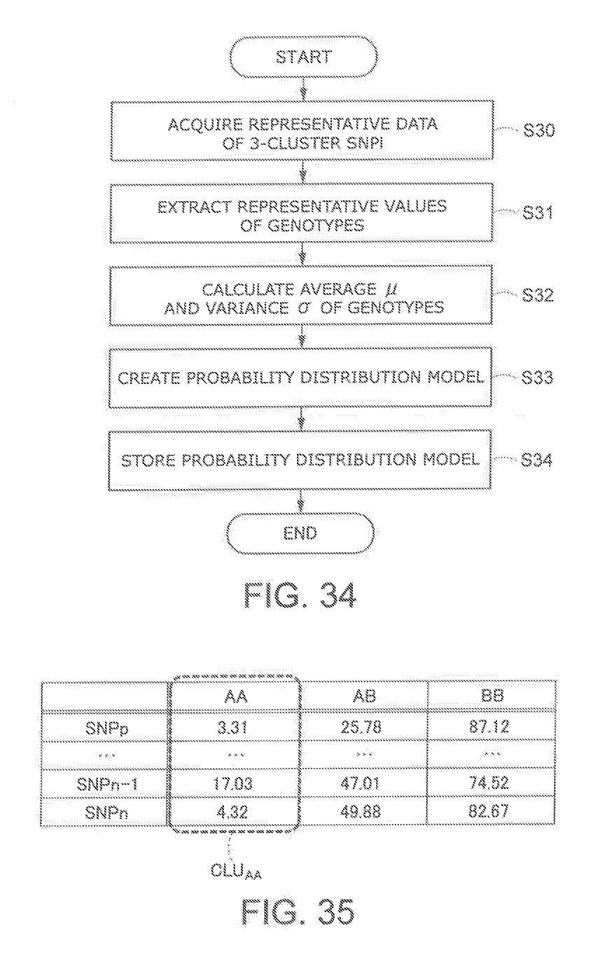

Next, the process of creating the probability distribution model in step S3 will be described. FIG. 34 is a flowchart that illustrates the processing to create the probability distribution model. In the following, it is assumed that the probability distribution model is created using normal distribution.

First, in step S30, the model creator 7 acquires representative value data of SNPs of the three clusters stored in the representative value DB 5. As a result, the updated representative value data as illustrated in FIG. 33 is acquired.

Next, in step S31, the model creator 7 extracts a representative value for each genotype. As illustrated in FIG. 35, the model creator 7 extracts, for example, as a representative value of the genotype “AA,” all representative values of the genotype “AA” included in the representative value data. The set of the extracted representative values of the genotype “AA” is hereinafter referred to as “CLU_{AA},” the set of the representative values of the genotype “AB” is hereinafter referred to as “CLU_{AB}” and the set of the representative values of the genotype “BB” is hereinafter referred to as “CLU_{BB}.”

Subsequently, in step S32, the model creator 7 calculates an average “μ” and a variance “δ” of each genotype. Specifically, the model creator 7 calculates the average and variance “σ_{AA}” of the set “CLU_{AA},” the average “μ_{AB}” and variance “σ_{AB}” of the set “CLU_{AB},” and the average “μ_{BB}” and variance “σ_{BB}” of the set “CLU_{BB}.”

In addition, in step S33, the model creator 7 applies the averages V and variances V of the respective genotype to the normal distribution, and generates the probability density function f(x) for each genotype. The probability density function is expressed by the following the expression.

$$\begin{matrix}[ Expression 2 ] & \\ {f}_{AA} ( x ) = \frac{1}{{σ}_{AA} \sqrt{2 π}} exp ( - \frac{{( x - {μ}_{AA} )}^{2}}{2 {σ}_{{AA}^{2}}} ) & ( 3 ) \\ {f}_{AB} ( x ) = \frac{1}{{σ}_{AB} \sqrt{2 π}} exp ( - \frac{{( x - {μ}_{AB} )}^{2}}{2 {σ}_{{AB}^{2}}} ) & ( 4 ) \\ {f}_{BB} ( x ) = \frac{1}{{σ}_{BB} \sqrt{2 π}} exp ( - \frac{{( x - {μ}_{BB} )}^{2}}{2 {σ}_{{BB}^{2}}} ) & ( 5 )\end{matrix}$$

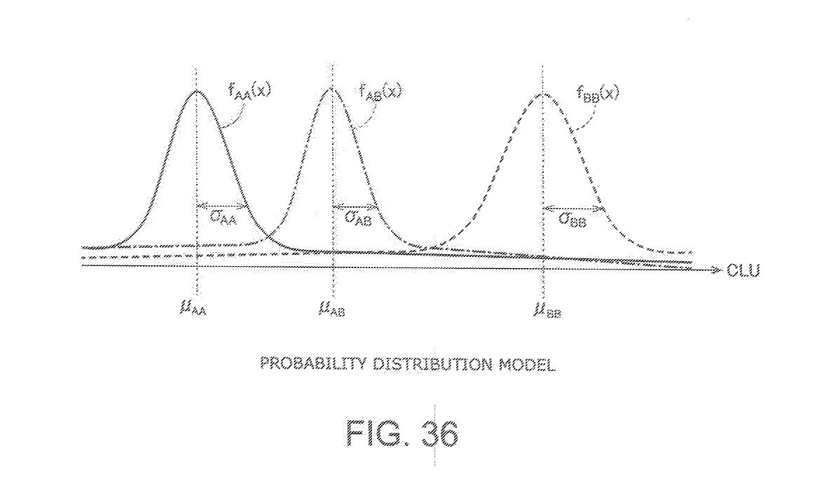

In the above expressions (3) to (5), “x” is a representative value “CLU,” “f_{AA}(x)” is the probability density function of the genotype “AA,” “f_{AB}(x)” is the probability density function of the genotype “AB,” and “f_{BB}(x)” is the probability density function of the genotype “BB.” The set of the above three probability density functions constitutes the probability distribution model. FIG. 36 is a diagram that illustrates an example of the probability distribution model created in step S33.

After creating the probability distribution model, the model creator 7 stores the probability distribution model in the model DB 8 in step S34, In the model DB 8, the averages “μ” and the variances V for the respective genotypes are stored.

(Step S4)

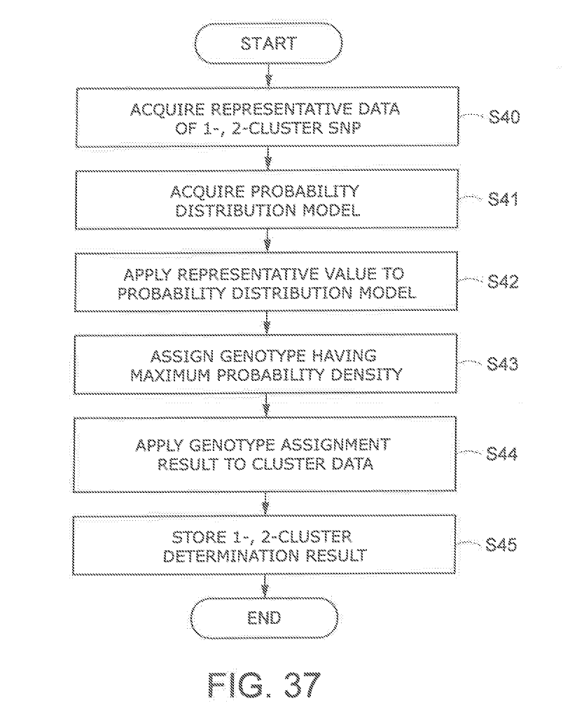

Next, the genotype assignment processing for one- or two-cluster SNPs (SNP classified as pertaining to the one cluster or SNP classified as pertaining to the two clusters) in step S4 will be described. FIG. 37 is a flowchart that illustrates the genotype assignment processing for the one- or two-cluster SNPs.

First, in step S40, the second labeler 9 acquires the representative value data of the one-cluster SNP or the two-cluster SNP stored in the representative value DB 5. As a result, the representative value data as illustrated in FIG., 26 and 27 is acquired.

Also, in step S41, the second labeler 9 acquires the probability distribution model stored in the model DB 8. As a result, the probability distribution model illustrated in FIG. 36 is acquired.

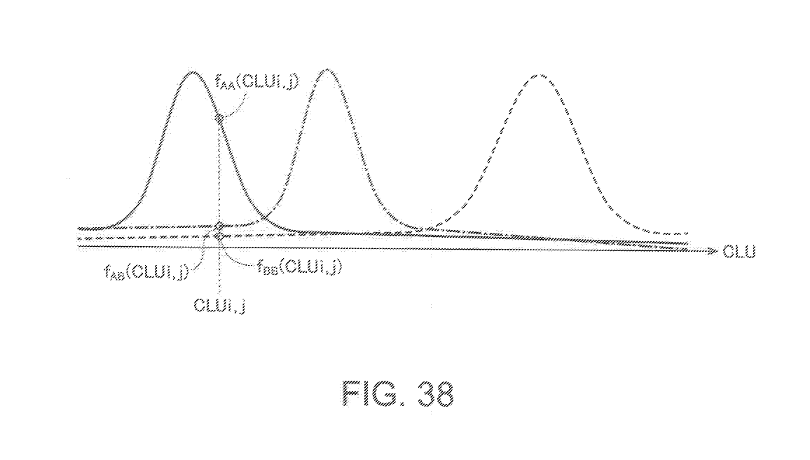

Next, in step S42, the second labeler 9 applies the representative value “CLU(i,j)” to the probability distribution model. Specifically, as illustrated in FIG. 38, the second labeler 9 substitutes the representative value “CLU(i,j)” to the probability density function “f(x)” of each genotype and calculates the probability density “f(CLU(i,j)).”

Subsequently, in step S43, the second labeler 9 assigns a genotype having the maximum probability density “f(CLU(i,j))” to “Cluster j” of SNPi. For example, in the example of FIG. 38, the genotype “AA” is assigned to “Cluster j” of SNPi.

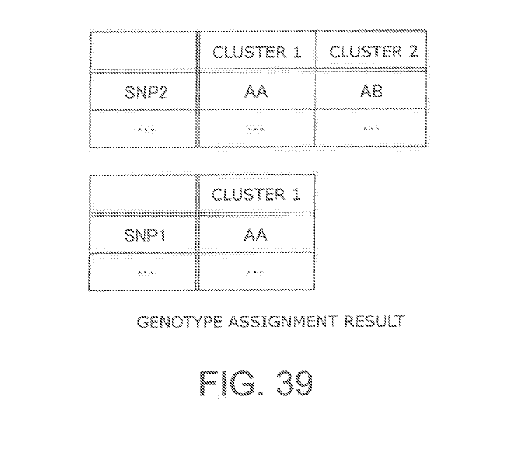

FIG. 39 is a diagram that illustrates an example of the result of the genotype assignment performed by the second labeler 9, Such a result of assignment is held in the second labeler 9. Further, the result of assignment may be stored in the determination result DB 10.

In addition, in step S44, the second labeler 9 applies the result of assignment of the genotypes for SNPi to the cluster data. Specifically, the second labeler 9 replaces the cluster of each specimen of SNPi stored in the cluster DB 3 with the genotype assigned to each cluster of SNPi. The method of applying the result of assignment is the same as in step S22.

When the second labeler 9 applies the result of assignment, the determination result of genotype of one-cluster SNP or two-cluster SNP as illustrated in FIG. 19 is generated.

In addition, in step S45, the generated result of determination is stored in the determination result DB 10. As a result, the determination of the genotypes of the SNPs 1 to “n” of the specimens 1 to “M” is completed.

As described above, according to this embodiment, the genotype is determined by using the probability distribution model reflecting the fluctuation of distribution due to the influence of the experimentation environment. Accordingly, errors in genotype assignment due to the influence of the experimentation environment can be suppressed, and the accuracy of genotyping can be improved.

(Second Embodiment)

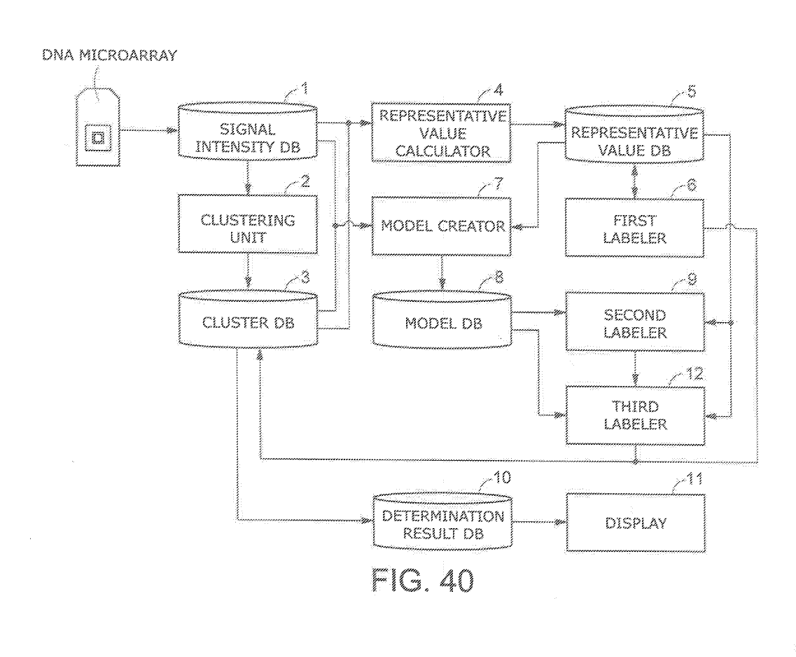

A second embodiment will be described below with reference to FIGS. 40 to 45. According to this embodiment. It is determined whether or not the reliability of the genotypes assigned by the second labeler 9 is high. When a genotype of the reliability is low, the genotype is reassigned. For the determination and reassignment, biological knowledge is used.

FIG. 40 is a functional block diagram that illustrates the determination device according to this embodiment. As illustrated in FIG. 40, the determination device according to this embodiment includes a third labeler 12. The other features are the same as those in FIG. 9.

The third labeler 12 is configured to acquire the result of the genotype assignment by the second labeler 9 and determine whether or not the reliability of the result of assignment is high.

If it is determined that the reliability of the result of assignment is low, the third labeler 12 outputs the result of assignment of the second labeler 9 on an as-is basis. On the other hand, if it is determined that the reliability of the result of assignment is low, the third labeler 12 reassigns the genotypes. In addition, the third labeler 12 outputs the result of assignment of the reassigned genotypes.

According to this embodiment, the results of determination of the genotypes of one-cluster and two-cluster SNPs are generated by applying the result of assignment that has been output by the third labeler 12 to the cluster data stored in the cluster DB 3.

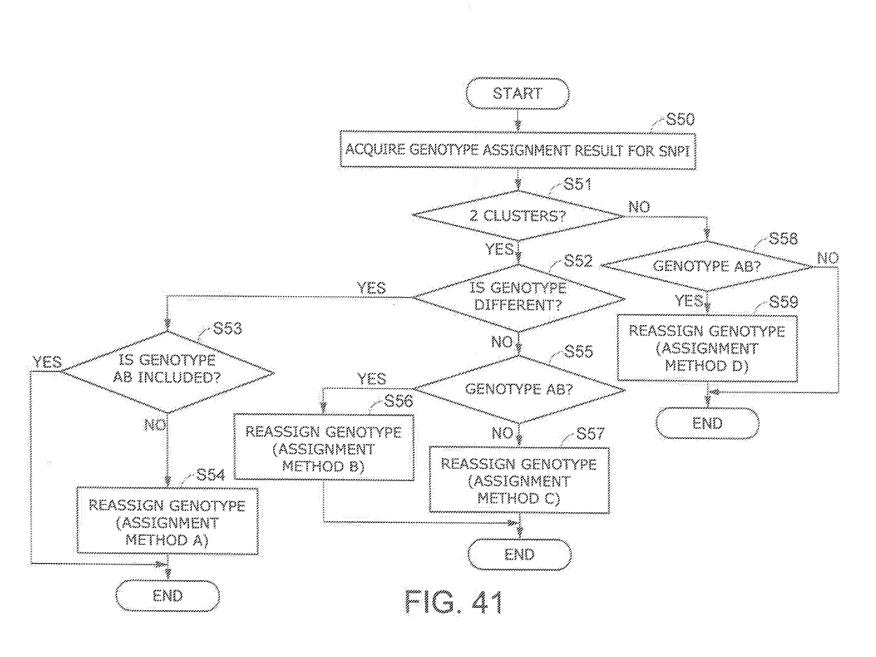

FIG. 41 is a flowchart that illustrates the process of reassigning the genotype reliability by the third labeler 12.

First, in step S50, the third labeler 12 acquires the result of the genotype assignment for SNPI from the second labeler 9. The SNPi acquired here is a one-cluster or two-cluster SNP.

Next, in step S51, the third labeler 12 determines whether or not the acquired SNPi is of one-cluster or two-cluster. When the SNPi is of two-cluster (Yes), the process proceeds to step S52.

In step S52, the third labeler 12 determines whether or not the two genotypes assigned to the SNPI of two-cluster are different genotypes. If they are different genotypes (Yes), the process proceeds to step S53.

In step S53, the third labeler 12 determines whether or not the genotype “AB” is included in the two genotypes assigned to the two-cluster SNPi. When the genotype “AB” is included (Yes), the third labeler 12 outputs the result of assignment acquired from the second labeler 9 on an as-is basis, and the reassignment processing is completed.

On the other hand, in step S53, If the genotype “AB” is not included in the two genotypes (No), the process proceeds to step S54.

In step S54, the third labeler 12 reassigns the genotype to the two clusters, i.e., the “Clusters 1 and 2” of SNPi using an assignment method A. The assignment method A will be described later. Thereafter, the third labeler 12 outputs the result of assignment of the reassigned genotype, and the reassignment process is completed.

Also, if the two genotypes assigned to the two-cluster SNPi are the same in step S52 (Yes), the process proceeds to step S55.

In step S55, the third labeler 12 determines whether or not the genotypes assigned to SNPi is “AB.” If the genotype “AB” is assigned to SNPi (YES), the process proceeds to step S56.

In step S56, the third labeler 12 reassigns the genotype to the two clusters, i.e., the “Clusters 1 and 2” of SNPi using an assignment method B. The assignment method B will be described later. Thereafter, the third labeler 12 outputs the result of assignment of the reassigned genotype, and the reassignment process is completed.

On the other hand, if the genotype “AB” has not been assigned to SNPi in step S55 (No), the process proceeds to step S57.

In step S57, the third labeler 12 reassigns the genotypes to the two clusters, i.e., the “Clusters 1 and 2” of SNPi using an assignment method C. The assignment method C will be described later. Thereafter, the third labeler 12 outputs the result of assignment of the reassigned genotype, and the reassignment process is completed.

Further, in step S51, if SNPi is of one cluster (No), the process proceeds to step S58.

In step S58, the third labeler 12 determines whether or not the genotype assigned to SNPi is “AB.” When the genotype “AB” is assigned to SNPi (Yes), the process proceeds to step S59.

In step S59, the third labeler 12 reassigns the genotype to one cluster, i.e., “Cluster 1” of the SNPi using an assignment method D. The assignment method D will be described later. Thereafter, the third labeler 12 outputs the result of assignment of the reassigned genotype, and the reassignment process is completed.

On the other hand, If the genotype “AB” is not assigned to SNPi (No) in step S58, the third labeler 12 outputs the result of assignment acquired from the second labeler 9 on an as-is basis, and the reassignment process is completed.

Next, the assignment methods A to D will be described.

(Assignment Method A)

The assignment method A will be described first. Reassignment by the assignment method A is carried out when the genotypes “AA” and “BB” are assigned to the two clusters of “Clusters 1 and 2” of SNPi.

The possibility that genotype of a certain ethnic group of humans results exclusively in the genotype “AA” or the genotype “BB” is considered to be biologically extremely low. This is because a child between a mother (father) of the genotype “AA” and a father (mother) of the genotype “BB” will have the genotype “AB” with a probability of 50%. Accordingly, from a biological point of view, the reliability of this result of assignment is determined to be low.

In such a case, the third labeler 12 first acquires a probability distribution model and a representative value data of SNPi. As a result, the probability density functions “f_{AA}(x),” “f_{AB}(x),” and “f_{BB(x),” the representative value “CLU(i,}1)” of “Cluster 1” and the representative value “CLU(i,2)” of the “Cluster 2” are acquired.

Next, the third labeler 12 substitutes the representative values to the probability density function “f_{AB}(x)” to calculate a probability density “f_{AB}(CLU(i,1))” and a probability density “f_{AB}(CLU(i,2)).” In addition, the third labeler 12 reassigns the genotype “AB” to a cluster having a high probability density “f_{AB}(x).” The genotype of the cluster with a small probability density “f_{AB}(x)” remains unchanged.

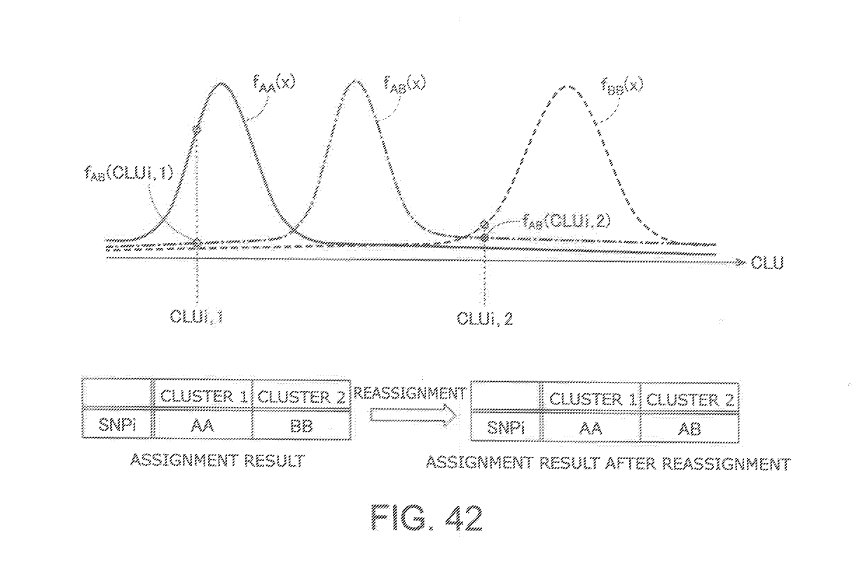

FIG. 42 is a diagram for explanation of the assignment method A. in FIG. 42, the genotype “AA” is assigned to “Cluster 1” and the genotype “BB” is assigned to the “Cluster 2.” Also, “f_{AB}(CLU(i,1))”<“f_{AB}(CLU(i,2)).” In the example of FIG. 42, the third labeler 12 reassigns the genotype “AB” to the “Cluster 2.” As a result, in the result of assignment after reassignment, the genotype of “Cluster 1” will be “AA” and the genotype of the “Cluster 2” will be “AB.”

(Assignment Method B)

Next, the assignment method B will be described. Reassignment by the assignment method B is carried out when the genotype “AB” is assigned to the two clusters of “Clusters 1 and 2” of SNPi. Since the same genotype is assigned to the two clusters, the reliability of this assignment result is determined to be low.

In such a case, the third labeler 12 first acquires the probability distribution model and the representative value data of SNPi. As a result, the probability density functions “f_{AA}(x),” “f_{AB}(x),” and “fₐₐ(x).” The representative value “CLU(i,1)” of “Cluster 1” and the representative value “CLU(i,2)” of the “Cluster 2” are acquired.

Next, the third labeler 12 substitutes the representative values to the probability density function “f_{AB}(x)” to calculate the probability density “f_{AB}(CLU(i,1))” and the probability density “fAB(CLU(i,2).” In addition, the third labeler 12 reassigns the genotype “AA” or “BB” to a cluster having a small probability density “f_{AB}(x).” The genotype of the cluster with a high probability density “f_{AB}(x)” remains to be “AB.”

The third labeler 12 calculates the probability densities “f_{AA}(x)” and “f_{BB}(x)” of clusters having a small probability density “f_{AA}(x).” In the case of “f_{AA}(x)”>“f_{BB}(x),” the third labeler 12 reassigns the genotype “AA” to a cluster having a small probability density “f_{AB}(x).” On the other hand, in the case of “f_{AA}(x)”<“f_{BB}(x),” the third labeler 12 reassigns the

genotype “BB” to the cluster having the small probability density “f_{AB}(x).”

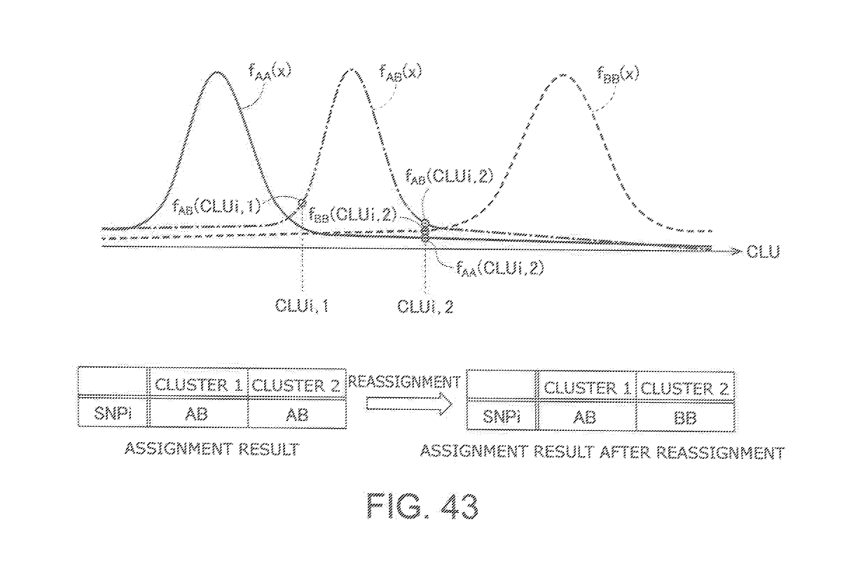

FIG. 43 is a diagram for explanation of the assignment method B. in FIG. 43, the genotype “AB” is assigned to the “Clusters 1 and 2.” Also, “f_{AB}(CLU(i,1))”>“f_{AB}(CLU(i,2))” and “f_{BB}(CLU(i,2))”>“f_{AA}(CLU(i,2)),” in the example of FIG. 43, the third labeler 12 reassigns the genotype “BB” to the “Cluster 2.” As a result, in the result of assignment after reassignment, the genotype of “Cluster 1” will be “AB” and the genotype of the “Cluster 2” will be “BB.”

With regard to the assignment method B, the reason why the genotype of one of the clusters is left as “AB” is that the possibility that the genotype results exclusively in “AA” or “BB” is considered to be biologically extremely low as mentioned above.

(Assignment Method C)

Next, the assignment method C will be described. Reassignment by the assignment method C is carried out when the genotype “AA” or genotype “BB” is assigned to either one of the two clusters of “Clusters 1 and 2” of SNPi. Since the same genotype is assigned to the two clusters, the reliability of this assignment result is determined to be low.

In such a case, the third labeler 12 first acquires the probability distribution model and the representative value data of SNPi. As a result, the probability density functions “f_{AA}(x),” “f_{AB}(x),” and “f_{BB}(x),” the representative value “CLU(i,1)” of “Cluster 1” and the representative value “CLU(i,2)” of “Cluster 2” are acquired.

When the genotype “AA” is assigned to “Clusters 1 and 2,” the third labeler 12 substitutes each representative value to the probability density function “f_{AA}(x)” to calculate the probability density “f_{AA}(CLU(i,1))” and the probability density “f_{AA}(CLU(i,1)).” In addition, the third labeler 12 reassigns the genotype “AB” to a cluster having a small probability density “f_{AA}(x).” The genotype of the cluster with a high probability density “f_{AA}(x)” remains to be “AA.”

On the other hand, when the genotype “BB” is assigned to “Clusters 1 and 2,” the third labeler 12 substitutes each representative value to the probability density function “f_{BB}(x)” to calculate the probability density “f_{BB}(CLU(i,1))” and the probability density “f_{BB}(CLU(i,2)).” In addition, the third labeler 12 reassigns the genotype “AB” to a cluster having a small probability density “f_{BB}(x).” The genotype of the cluster with a large probability density “f_{BB}(x)” remains to be “BB.”

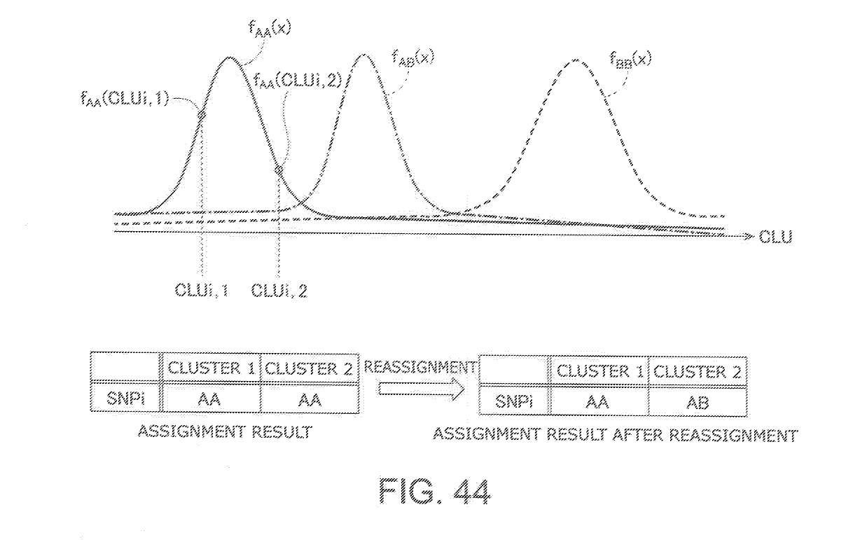

FIG. 44 is a diagram for explanation of the assignment method C. in FIG. 44, the genotype “AA” is assigned to the “Clusters 1 and 2.” Also, “f_{AA}(CLU(i,1))”>“f_{AA}(CLU(i,2)).” In the example of FIG. 44, the third labeler 12 reassigns the genotype “AB” to the “Cluster 2.” As a result, in the result of assignment after reassignment, the genotype of “Cluster 1” will be “AA” and the genotype of “Cluster 2” will be “AB.”

In the assignment method C, the reason why the genotype of one cluster is reassigned to AB is that the possibility that the genotype is divided only to AA or BB is considered to be biologically extremely low as mentioned above.

(Assignment Method D)

Next, the assignment method D will be described. Reassignment by the assignment method D is carried out when the genotype “AB” is assigned to one-cluster SNPi.

The possibility that the genotype of a certain ethnic group of humans results exclusively in the genotype “AB” for all the members is considered biologically extremely low. This is because if both of the parents have the genotype “AB,” such a homozygous child that has the genotype “AA” or “BB” appears with a probability of about 50%. In addition, if the genotype of all members of a large population is “AB,” then only the combination of a mother (father) of the genotype “AA” and a father (mother) of the genotype BB can be considered as the parents of the individuals. Accordingly, from a biological point of view, the reliability of this result of assignment is determined to be low.

In such a case, the third labeler 12 first acquires the probability distribution model and the representative value data of SNPi. As a result, the probability density functions “f_{AA}(x),” “f_{AB}(x),” and “f_{BB}(x)” and the representative value “CLU(i,1)” of “Cluster 1” are acquired.

Next, the third labeler 12 substitutes the representative value “CLU(i,1)” to the probability density functions “f_{AA}(x)” and “f_{BB}(x)” to calculate the probability densities “f_{AA}(CLU(i, 1))” and “f_{BB}CLU(i,1)).” In addition, in the case of “f_{AA}(CLU(i,1)”>“f_{BB}(CLU(i,1)),” the third labeler 12 reassigns the genotype “AA” to “Cluster 1” and in the case of “f_{AA}(CLU(i,1))”<“f_{BB}(CLU(i,l),” the genotype “BB” is reassigned to “Cluster 1.”

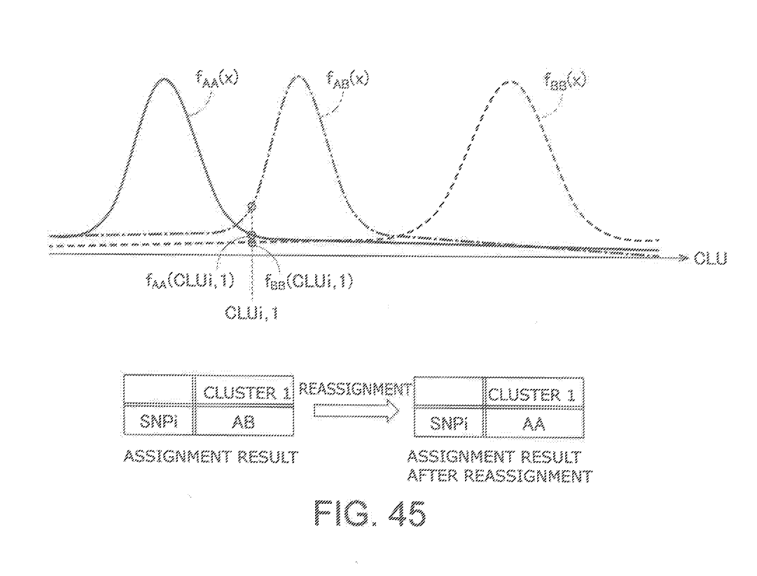

FIG. 45 is a diagram for explanation of the assignment method D, in FIG. 45, the genotype “AB” is assigned to “Cluster 1.” Also, “f_{AA}(CLU(i,1))”>“f_{BB}(CLU(i,1)).” In the example of FIG. 45, the third labeler 12 reassigns the genotype “AA” to “Cluster 1.” As a result, given that the result of assignment after reassignment, the genotype of “Cluster 1” will be “AA.”

As described above, according to this embodiment, it is possible to reassign a genotype to a cluster to which a genotype with low reliability is assigned by using biological knowledge. Accordingly, the reliability of genotype assignment is improved, and as a result, the accuracy of genotyping can be improved.

(Third Embodiment)

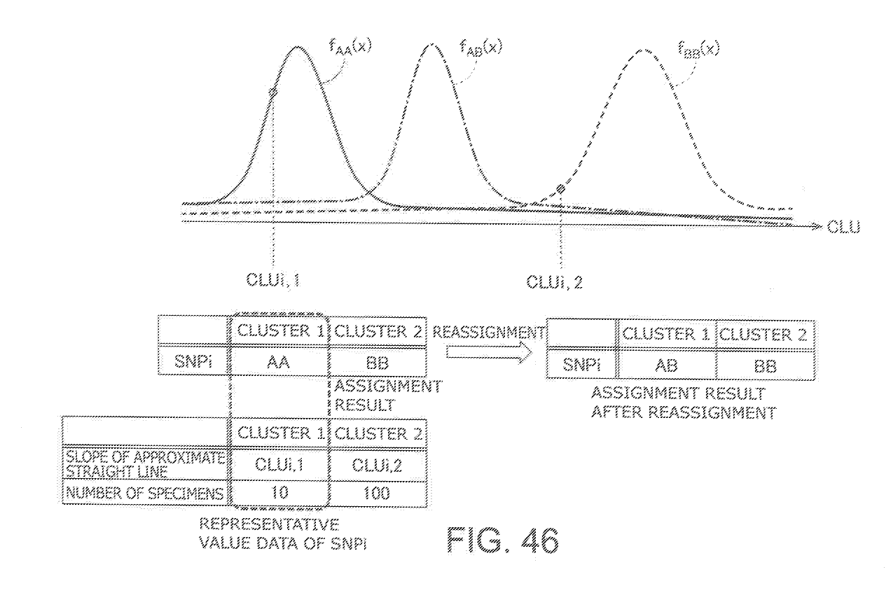

A third embodiment will be described below with reference to FIGS. 46 to 48. According to this embodiment, the third labeler 12 reassigns the genotype using a second representative value. The second representative value is a representative value of a type different from the representative value (hereinafter referred to as “first representative value”) used by the first labeler 6 and the second labeler 9. Accordingly, at least two kinds of representative values Including the first representative value and the second representative value are calculated according to this embodiment.

The second representative value may be calculated based on the signal intensities “A” and “B.” Such a representative value may include, for example, a regression coefficient of a regression line of each cluster, an arc tangent of a regression coefficient, a gradient of an approximate straight line passing through the origin, a correlation coefficient of each cluster, a cluster center value, a cluster median value, a cluster variance, an average value of ratios, and an average value of differences.

Also, the second representative value may not be calculated based on the signal intensities “A” and “B.” As such a representative value, for example, the number of specimens can be mentioned. The number of specimens is the number of specimens included in each cluster.

According to this embodiment, the method of determining the reliability of genotypes by the third labeler 12 is the same as that of the second embodiment (see the flowchart of FIG. 41). Meanwhile, according to this embodiment, the assignment methods A to C differ from those in the second embodiment. Accordingly, the assignment methods A to C according to this embodiment will be described. In the following, it is assumed that the first representative value is the slope of the approximate straight line of the cluster and the second representative value is the number of specimens.

(Assignment Method A)

First, the assignment method A will be described. Reassignment by the assignment method A is carried out when the genotypes “AA” and “BB” are assigned to the two clusters of “Clusters 1 and 2” of SNPi.

According to this embodiment, the third labeler 12 reassigns the genotype “AB” to a cluster having a small number of specimens. This is because clusters with a small number of specimens are considered to have low reliability in their genotype assignment. The genotype of the cluster with many specimens is left unchanged.

FIG. 46 is a diagram for explanation of the assignment method A according to this embodiment. in FIG. 46, the genotype “AA” is assigned to “Cluster 1” and the genotype “BB” is assigned to “Cluster 2.” The number of specimens in “Cluster 1” is 10, and the number of specimens in “Cluster 2” is 100, in the example of FIG. 46, the third labeler 12 reassigns the genotype “AB” to “Cluster 1” As a result, given that the result of assignment after reassignment, the genotype of “Cluster 1” will be “AB,” and the genotype of “Cluster 2” will be “BB.”

(Assignment Method B)

Next, the assignment method B will be described. Reassignment by the assignment method B is carried out when the genotype “AB” is assigned to the two clusters of “Clusters 1 and 2” of SNPi.

According to this embodiment, the third labeler 12 reassigns the genotype “AA” or “BB” to a cluster having a small number of specimens. This is because clusters with a small number of specimens are considered to have low reliability in their genotype assignment. The genotype of the cluster with many specimens remains to be “AB.”

The third labeler 12 should reassign a genotype to a cluster having a small number of specimens in the same manner as in the second embodiment. Specifically, the third labeler 12 calculates the probability densities “f_{AA}(x)” and “f_{BB}(x),” reassigns the genotype “AA” in the case of “f_{AA}(x)”>“f_{BB}(x),” and reassigns the genotype “BB” in the case of “f_{AA}(x)”<“f_{BB}(x).”

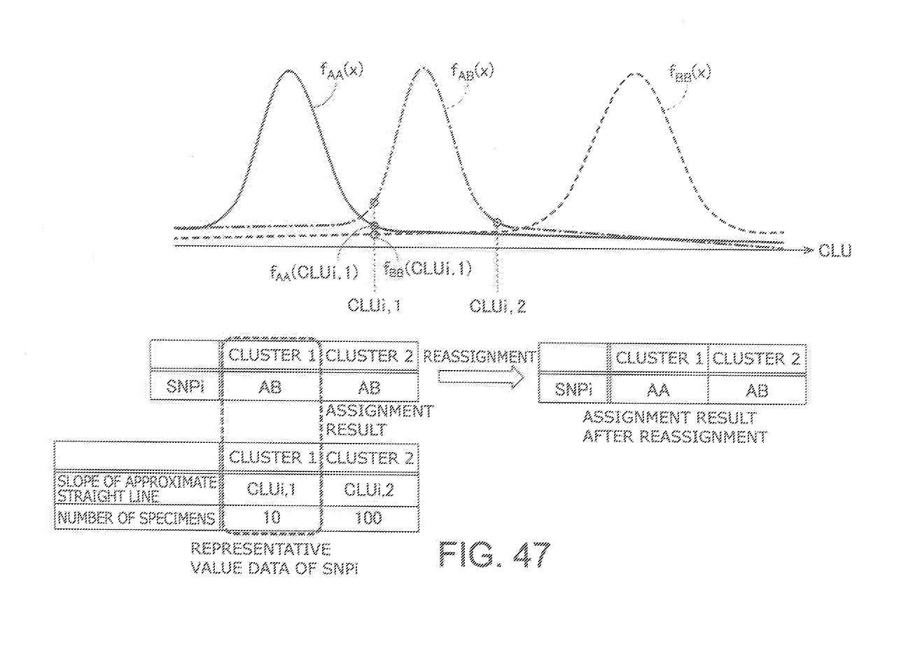

FIG. 47 is a diagram for explanation of the assignment method B according to this embodiment. In FIG. 47, the genotype “AB” is assigned to “Clusters 1 and 2.” The number of specimens in “Cluster 1” is 10, the number of specimens in “Cluster 2” is 100, and “f_{AA}(CLU(i,1)”>“f_{BB}(CLU(i,1)).” In the example of FIG. 47, the third labeler 12 reassigns the genotype “AA” to “Cluster 1,” As a result, given that the result of assignment after reassignment, the genotype of “Cluster 1” will be “AA” and the genotype of “Cluster 2” will be “AB.”

(Assignment Method C)

Next, the assignment method C will be described. Reassignment by the assignment method C is carried out when the genotype “AA” or the genotype “BB” is assigned to both of the two clusters of “Clusters 1 and 2” of SNPi.

According to this embodiment, the third labeler 12 reassigns the genotype “AB” to a cluster having a small number of specimens. This is because clusters with a small number of specimens are considered to have low reliability in terms of the genotype assignment. The genotypes of the clusters with many specimens are left unchanged.

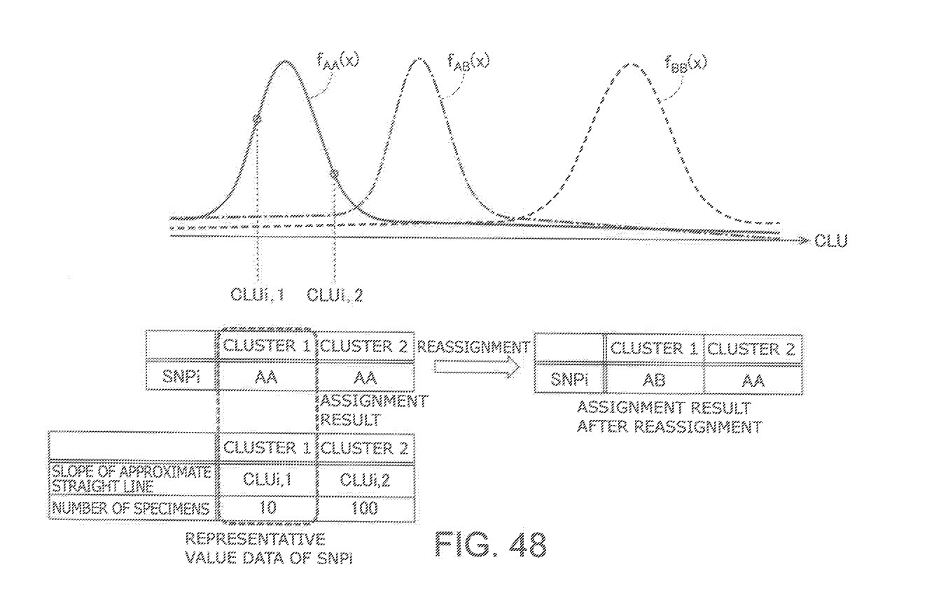

FIG. 48 is a diagram for explanation of the assignment method C in this embodiment. in FIG. 48, the genotype “AA” is assigned to the “Clusters 1 and 2.” Also, the number of specimens in “Cluster 1” is 10, and the number of specimens in “Cluster 2” is 100. In the example of FIG. 48, the third labeler 12 reassigns the genotype “AB” to “Cluster 1.” As a result, given that the result of assignment after the reassignment, the genotype of “Cluster 1” will be “AB” and the genotype of “Cluster 2” will be “AA.”

As explained above, according to this embodiment, genotypes are reassigned using the second representative value. If the reliability of the genotype assignment is low due to the low reliability of the first representative value, the reliability of the assignment of the genotypes can be improved through the reassignment using the second representative value, which leads to improvement of the accuracy of the genotyping.

It should be noted that with regard to the assignment methods A to C, it is also possible to use the method of this embodiment and the method of the second embodiment in combination. For example, it can be considered that, if the threshold value “α” of the number of specimens is set and at least one of the numbers of specimens in the “Clusters 1 and 2” is equal to or less than the threshold value “α” then the genotype is reassigned by the method of this embodiment and, if the number of specimens is greater than the threshold value “α” then the genotype is reassigned by the method of the second embodiment.

In addition, the model creator 7 may create a second probability distribution model on the basis of the second representative value, the model DB 8 may store the second probability distribution model, and the third labeler 12 may carry out the reassignment of the genotypes on the basis of the second representative value and the second probability distribution model.

Further, the representative value calculator 4 may calculate three or more representative values for each cluster, and the third labeler 12 may carry out the reassignment of the genotypes using two or more types of representative values other than the first representative value.

(Fourth Embodiment)

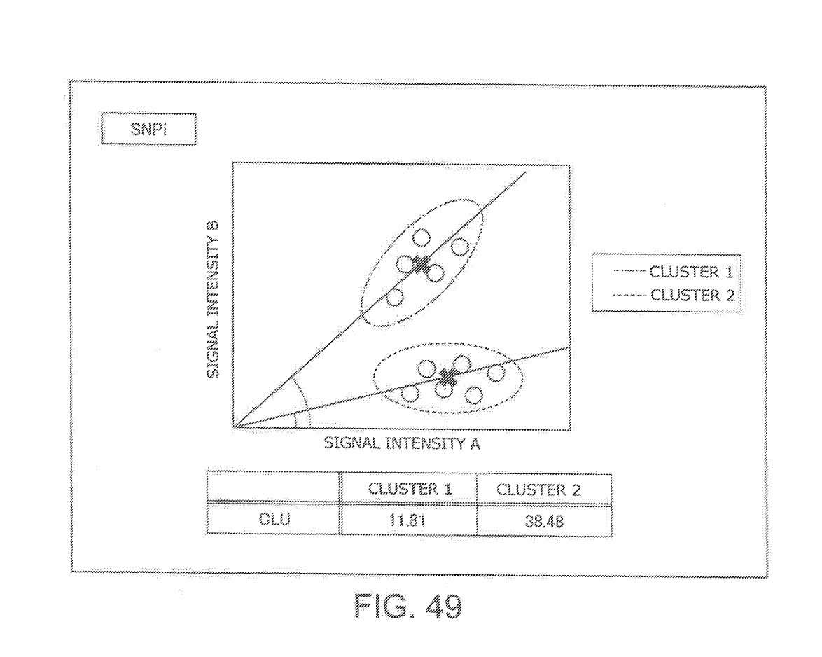

A fourth embodiment will be described below with reference to FIGS. 49 to 52, in the context of the fourth embodiment, a screen displayed on the display device 103 by the display 11 will be described. FIGS. 49 to 52 are diagrams that Illustrate examples of the screen.

In the screen of FIG. 49, the result of clustering and the result of calculation of the representative values are visualized and displayed. The display 11 acquires the signal intensity data, the cluster data, and the representative value data of SNPI from the signal intensity DB 1, the cluster DB 3, and the representative value DB 5, respectively, and the display 11 can cause the display device 103 to display the screen of FIG. 49 by using the acquired various date.

In the screen of FIG. 49, the type of the SNP (SNPi) being displayed, the specimens plotted in the signal intensity plane, the clusters (“Clusters 1 and 2”) generated for the SNPi and the cluster center, and a table Indicating the representative values (CLU) calculated for each cluster are displayed. In the example of FIG. 49, the representative value of “Cluster 1” is 11.81.

Since the display 11 displays such a screen, the user of the determination device can readily grasp the clusters and the representative values. It should be noted that when a plurality of types of representative values are calculated as in the third embodiment, the representative value table in FIG. 49 may be made to include a plurality of rows and the representative values of each type may be presented as a list.

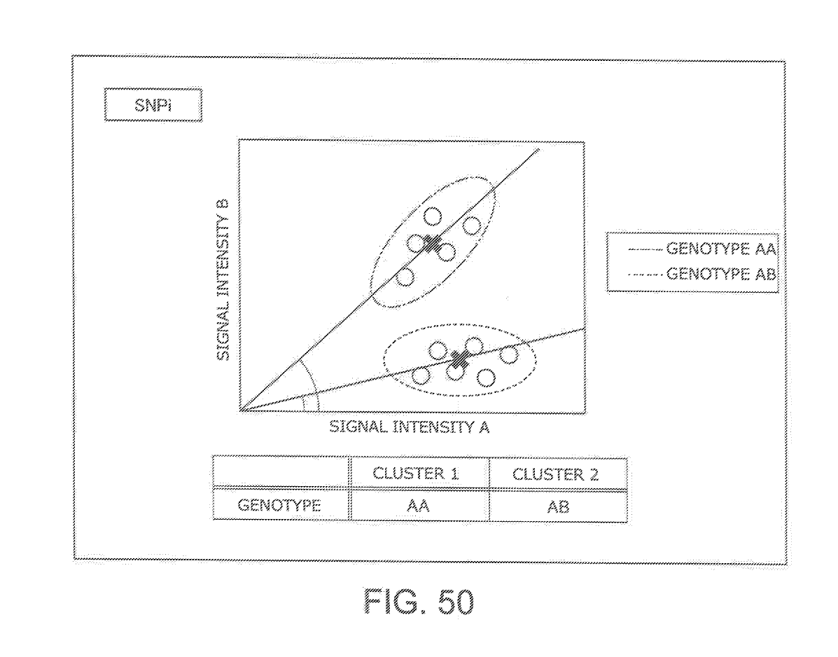

In the screen of FIG. 50, the result of clustering and the result of genotyping are visualized and displayed. The display 11 acquires the signal intensity data, the cluster data, and the result of determination of SNPi from the signal intensity DB 1, the cluster DB 3, and the determination result DB 10, respectively, and the display 11 can cause the display device 103 to display the screen of FIG. 50 by using the acquired various pieces of data.

In the screen of FIG. 50, the type of the SNP (SNPi) being displayed, the specimens plotted in the signal intensity plane, the clusters (“Clusters 1 and 2”) generated for the SNPi and the cluster center, and a table indicating the genotypes assigned to the clusters are displayed. in the example of FIG. 50, the genotype of “Cluster 1” is “AA.”

Since the display 11 displays such a screen, the user of the determination device can readily grasp the results of determination (assignment result) of the clusters and the genotypes.

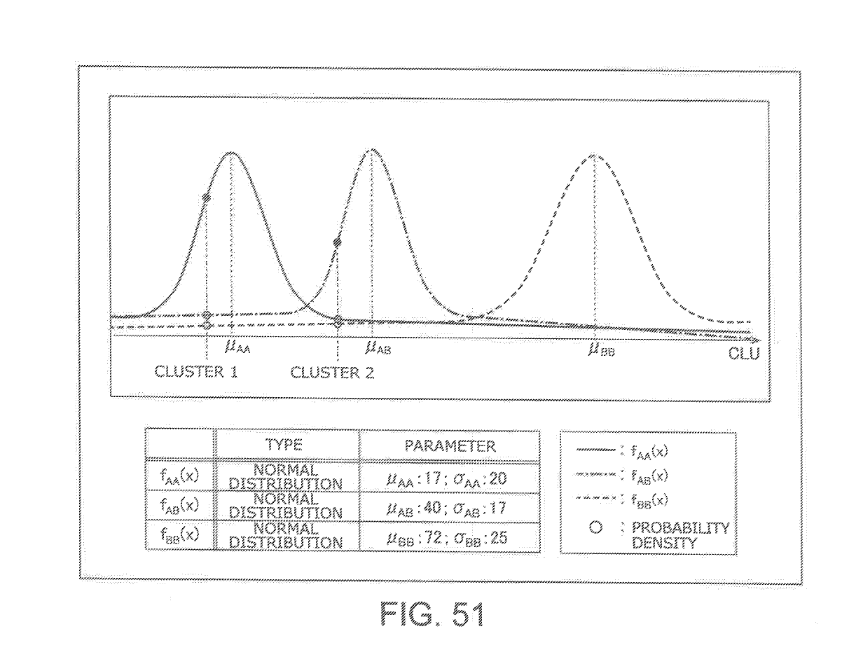

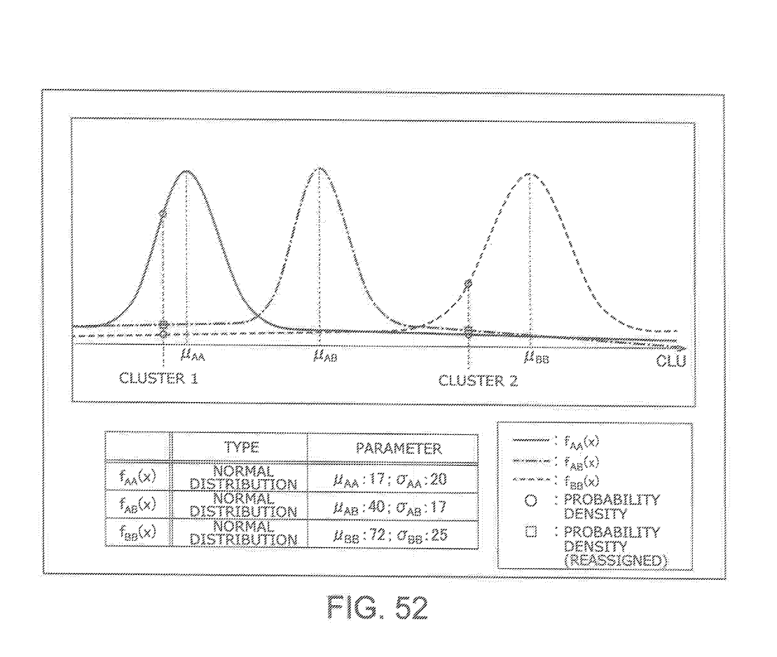

In the screen of FIG. 51, the probability distribution model is visualized and displayed. The display 11 can acquire the data (parameters, etc,) of the probability distribution model from the model DB 8 and display the screen of FIG. 51 on the display device 103 using the acquired data.

In the screen of FIG. 51, there are shown a probability distribution model represented in the form of a graph, the type (normal distribution) of the respective probability density functions constituting the probability distribution model, and a table indicating the parameters (μ,σ) are indicated. For example, in the example of FIG. 51, the probability density function “f_{AA}(x)” follows a normal distribution, the average “μ_{AA}” is 17, and the variance “σ_{AA” is} 20.

Also, on the graph of FIG. 51, the probability densities calculated to determine the genotypes of the clusters are plotted. The solid circles are plotted on the probability density functions of the genotypes assigned to the clusters and the hollow circles are plotted on the probability density functions of the other genotypes.

Since the display 11 displays such a screen, the user of the determination device can readily grasp the created probability distribution model and the basis (probability density) of the genotype assignment.

It should be noted that, when the genotype is reassigned by the third labeler 12, the probability density used in the reassignment may be plotted on the probability density function as illustrated in FIG. 52. In FIG. 52, the probability densities used in the reassignment are plotted with squares and displayed so as to be distinguishable from the probability densities used by the second labeler 9 for the assignment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A genotyping device comprising:
a representative value calculator configured to calculate a representative value for each of one or more clusters each including a plurality of specimens with respect to each of a plurality of SNPs, the specimens being classified based on signal intensities of the specimens into the clusters with respect to each of the SNPs, and the representative value being calculated based on the signal intensities of the specimens included in each of the clusters;
a first labeler configured to assign genotypes to clusters of an SNP pertaining to three clusters among the SNPs on the basis of the representative values of the clusters of the SNP pertaining to three clusters;
a model creator configured to create a model indicative of a relationship between the genotypes of the clusters of the SNP pertaining to the three clusters among the SNPs and the representative values of the clusters of the SNP pertaining to three clusters; and
a second labeler configured to assign genotypes to clusters of an SNP pertaining to one or two clusters among the SNPs on the basis of the representative values of the clusters of the SNP pertaining to one or two clusters and the model.

2. The genotyping device according to claim 1, wherein the signal intensity is a fluorescence intensity, an electric current intensity, or a converted value that is converted based on their values.

3. The genotyping device according to claim 1, wherein the representative value is at least one of a regression coefficient of a regression line of the specimens included in the cluster, an arc tangent of the regression coefficient, a slope of an approximate straight line passing an origin, a correlation coefficient, a cluster center value, a cluster median value, a cluster variance, an average value of ratios, and an average value of differences.

4. The genotyping device according to claim 1, wherein the first labeler is configured to assign one homozygous genotype, a heterozygous genotype, and another homozygous genotype to the clusters in order of the representative values of the clusters.

5. The genotyping device according to claim 1, wherein the model is a probability density function according to probability distribution of the representative values for each genotype.

6. The genotyping device according to claim 5, wherein the probability distribution is a mixed Gaussian distribution, a normal distribution, a beta distribution, or an F distribution.

7. The genotyping device according to claim 1, wherein the second labeler is configured to assign the genotype having a maximum probability density of the representative value to the cluster.

8. The genotyping device according to claim 1 further comprising a third labeler configured to reassign, when different genotypes of a homozygous type are assigned to the respective clusters of the SNP pertaining two clusters, the genotype of a heterozygous type to one of the clusters on the basis of the representative values of the clusters.

9. The genotyping device according to claim 1 further comprising a third labeler configured to reassign, when the genotype of a heterozygous type are assigned to the respective clusters of the SNP as pertaining to two clusters, the genotype of a homozygous type to one of the clusters on the basis of the representative values of the clusters.

10. The genotyping device according to claim further comprising a third labeler configured to reassign, when the same genotype of a homozygous type are assigned to the respective clusters of the SNP pertaining to two clusters, the genotype of a heterozygous type to one of the clusters on the basis of the representative values of the clusters.

11. The genotyping device according to claim 1 further comprising a third labeler configured to reassign, when the genotype of a heterozygous type is assigned to the cluster of the SNP pertaining to one cluster, the genotype of a homozygous type.

12. The genotyping device according to claim 1, wherein the representative value calculator is configured to calculate a second representative value of each of the clusters for each of the SNPs.

13. The genotyping device according to claim 12, wherein the second representative value is a number of the specimens included in each cluster.

14. The genotyping device according to claim 12 further comprising a third labeler configured to reassign, when different genotypes of a homozygous type are assigned to the respective clusters of the SNP pertaining to two clusters, the genotype of a heterozygous type to one of the clusters on the basis of the second representative value.

15. The genotyping device according to claim 12 further comprising a third labeler configured to reassign, when the genotypes of a heterozygous type are assigned to the clusters of the SNP pertaining to two clusters, the genotype of a homozygous type to one of the clusters on the basis of the second representative value.

16. The genotyping device according to claim 12 further comprising a third labeler configured to reassign, when the same genotypes of a homozygous type are assigned to the respective clusters of the SNPs classified as pertaining to two clusters the genotype of a heterozygous type to one of the clusters on the basis of the second representative value.

17. The genotyping device according to claim 1 further comprising a display configured to display at least one of the model, the result of determination, and the representative value.

18. A genotyping method comprising:
calculating a representative value for each of one or more clusters each including a plurality of specimens with respect to each of a plurality of SNPs, the specimens being classified based on signal intensities of the specimens into the clusters with respect to each of the SNPs, and the representative value being calculated based on the signal intensities of the specimens included in each of the clusters;
assigning genotypes to clusters of an SNP pertaining to three clusters among the SNPs on the basis of the representative values of the clusters of the SNP pertaining to three clusters;
creating a model indicative of a relationship between the genotypes of the clusters of the SNP pertaining to the three clusters among the SNPs and the representative values of the clusters of the SNP pertaining to three clusters; and
assign genotypes to clusters of an SNP pertaining to one or two clusters among the SNPs on the basis of the representative values of the clusters of the SNP pertaining to one or two clusters and the model.

19. A genotyping program for causing a computer to execute processes comprising:
calculating a representative value for each of one or more clusters each including a plurality of specimens with respect to each of a plurality of SNPs, the specimens being classified based on signal intensities of the specimens into the clusters with respect to each of the SNPs, and the representative value being calculated based on the signal intensities of the specimens included in each of the clusters;
assigning genotypes to clusters of an SNP pertaining to three clusters among the SNPs on the basis of the representative values of the clusters of the SNP pertaining to three clusters;
creating a model indicative of a relationship between the genotypes of the clusters of the SNP pertaining to the three clusters among the SNPs and the representative values of the clusters of the SNP pertaining to three clusters; and
assign genotypes to clusters of an SNP pertaining to one or two clusters among the SNPs on the basis of the representative values of the clusters of the SNP pertaining to one or two clusters and the model.

20. A genotyping device comprising a labeler configured to assign genotypes to clusters of an SNP pertaining to one or two clusters among SNPs, specimens being classified based on signal intensities of the specimens into one or more clusters with respect to each of a plurality of SNPs, wherein
the labeler assigns the genotypes to the clusters of the SNP pertaining to the one or two clusters among the SNPs on the basis of
representative values based on intensity signals of specimens included in the clusters of the SNP pertaining to the one or two clusters among the SNPs and
a model indicative of a relationship between: the genotypes of the clusters of an SNP pertaining to three clusters among the SNPs; and representative values based on intensity signals of specimens included in the clusters of the SNP pertaining to the three clusters.

21. The genotyping device according to claim 20 further comprising a model creator configured to create a model indicative of a relationship between the genotypes of the clusters of the SNP pertaining to the three clusters among the SNPs and the representative values of the clusters of the SNP pertaining to the three clusters,
wherein the labeler assigns the genotypes to the clusters of the SNP pertaining to the one or two clusters, on the basis of the model and the representative values of the clusters of the SNP pertaining to the one or two clusters.
